(19) United States
(12) Patent Application Publication
(10) Pub. No.: US 2023/0198021 A1
(43) Pub. Date: Jun. 22, 2023

(54) ELECTROLYTIC SOLUTION FOR SECONDARY BATTERY, AND SECONDARY BATTERY

(71) Applicant: MURATA MANUFACTURING CO., LTD., Kyoto (JP)

(72) Inventors: Midori SAITOU, Kyoto (JP); Takuju HASHIMOTO, Kyoto (JP)

(21) Appl. No.: 18/173,233

(22) Filed: Feb. 23, 2023

Related U.S. Application Data
(63) Continuation of application No. PCT/JP2021/033946, filed on Sep. 15, 2021.

(30) Foreign Application Priority Data
Sep. 28, 2020 (JP) 2020-162258

(51) Int. Cl. H01M 10/0567; H01M 10/0525

(52) U.S. Cl. CPC H01M 10/0567; H01M 10/0525; H01M 2300/0025

(57) ABSTRACT

A secondary battery includes a positive electrode, a negative electrode, and an electrolytic solution. The electrolytic solution includes a solvent, an electrolyte salt, a diester compound represented by Formula (1), and at least one of respective sulfur-containing compounds represented by Formulae (2) to (14).

### CROSS REFERENCE TO RELATED APPLICATIONS

The present application is a continuation of PCT patent application no. PCT/JP2021/033946, filed on Sep. 15, 2021, which claims priority to Japanese patent application no. JP 2020-162258, filed on Sep. 28, 2020, the entire contents of which are incorporated herein by reference.

### BACKGROUND

The present application relates to an electrolytic solution for a secondary battery, and a secondary battery.

Various kinds of electronic equipment, including mobile phones, have been widely used. Accordingly, a secondary battery is under development as a power source which is smaller in size and lighter in weight and allows for a higher energy density. The secondary battery includes a positive electrode, a negative electrode, and an electrolytic solution (an electrolytic solution for a secondary battery). A configuration of the secondary battery has been considered in various ways.

Specifically, in order to achieve superior high-temperature life performance and a superior low-temperature discharging characteristic, a non-aqueous electrolyte includes: ethylene carbonate, propylene carbonate, or both; a chain carboxylic acid ester; and a carbonyloxy ester compound. In order to achieve a superior earlier high-rate discharging characteristic and a superior post-storage high-rate discharging characteristic, an alkylene biscarbonate compound is included in a non-aqueous electrolytic solution. In order to suppress a reduction in discharge capacity during a charging and discharging cycle and in order to achieve a favorable low-temperature discharging characteristic, a cyclic carbonic acid ester, a chain carboxylic acid ester, and a diester compound are included in a non-aqueous electrolyte. In order to improve a low-temperature cyclability characteristic, a cyclic carbonic acid ester, a chain carbonic acid ester, an additive represented by R1-O—C(═O)—O— (CR3R4)ₙ—O—C(═O)—R2), and a monofluorophosphoric acid salt or difluorophosphoric acid salt are included in a non-aqueous electrolytic solution.

### SUMMARY

The present application relates to an electrolytic solution for a secondary battery, and a secondary battery.

Although consideration has been given in various ways regarding a battery characteristic of a secondary battery, a storage characteristic of the secondary battery is not sufficient yet. Accordingly, there is room for improvement in terms thereof.

It is therefore desirable to provide an electrolytic solution for a secondary battery and a secondary battery each of which makes it possible to achieve a superior storage characteristic.

An electrolytic solution for a secondary battery according to an embodiment of the present technology includes a solvent, an electrolyte salt, a diester compound represented by Formula (1), and at least one of respective sulfur-containing compounds represented by Formulae (2) to (14).

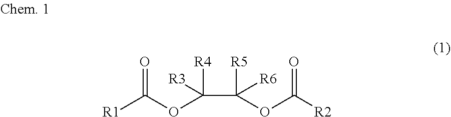

where:
each of R1 and R2 is one of a halogen group, an alkyl group, an alkoxy group, a halogenated alkyl group, or a halogenated alkoxy group; and
each of R3 to R6 is one of a hydrogen group, a halogen group, an alkyl group, or a halogenated alkyl group.

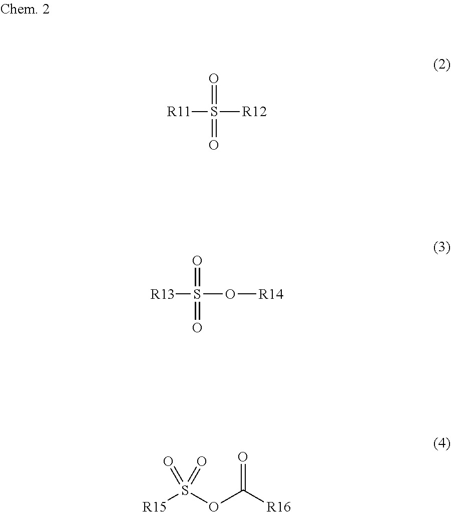

where:
each of R11 and R12 is one of an alkyl group, an alkenyl group, an aryl group, a halogenated alkyl group, a halogenated alkenyl group, or a halogenated aryl group;
R11 and R12 are optionally bonded to each other;
R13 is one of an alkyl group, an aryl group, a hydroxyalkyl group, a lithium alkoxide group, a halogenated alkyl group, or a halogenated aryl group;
R14 is one of a hydrogen group, a lithium group, an alkyl group, or a halogenated alkyl group;
each of R15 and R16 is one of an alkyl group, an alkenyl group, an aryl group, a halogenated alkyl group, a halogenated alkenyl group, or a halogenated aryl group; and
R15 and R16 are optionally bonded to each other.

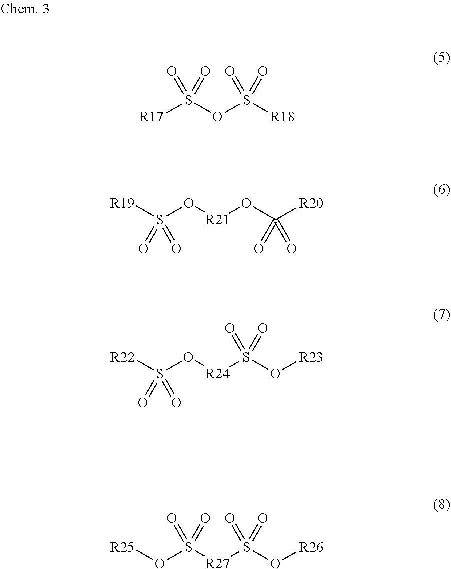

where:
each of R17 and R18 is one of an alkyl group, an alkenyl group, an aryl group, a halogenated alkyl group, a halogenated alkenyl group, or a halogenated aryl group;
R17 and R18 are optionally bonded to each other; each of R19 and R20 is one of an alkyl group or a halogenated alkyl group;
R21 is one of an alkylene group or a halogenated alkylene group;
R22 is one of an alkyl group or a halogenated alkyl group;
R23 is one of a hydrogen group, a lithium group, an alkyl group, or a halogenated alkyl group;
R24 is one of an alkylene group or a halogenated alkylene group;
each of R25 and R26 is one of a hydrogen group, a lithium group, an alkyl group, or a halogenated alkyl group, and
R27 is one of an alkylene group or a halogenated alkylene group.

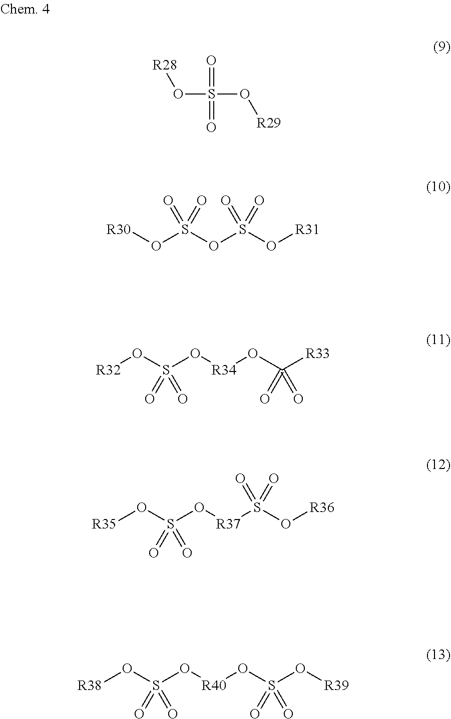

where:
each of R28 and R29 is one of a hydrogen group, a lithium group, an alkyl group, a hydroxyalkyl group, a lithium alkoxide group, or a halogenated alkyl group;
R28 and R29 are optionally bonded to each other;
1,2-ethylenesulfate and 1-methyl-1,2-ethylenesulfate are excluded from the sulfur-containing compound represented by Formula (9); each of R30 and R31 is one of an alkyl group, an alkenyl group, an aryl group, a halogenated alkyl group, a halogenated alkenyl group, or a halogenated aryl group;
R30 and R31 are optionally bonded to each other;
R32 is one of a hydrogen group, a lithium group, an alkyl group, or a halogenated alkyl group;
R33 is one of an alkyl group or a halogenated alkyl group;
R34 is one of an alkylene group or a halogenated alkylene group;
each of R35 and R36 is one of a hydrogen group, a lithium group, an alkyl group, or a halogenated alkyl group;
R³⁷ is one of an alkylene group or a halogenated alkylene group;
each of R38 and R39 is one of a hydrogen group, a lithium group, an alkyl group, or a halogenated alkyl group; and
R40 is one of an alkylene group or a halogenated alkylene group.

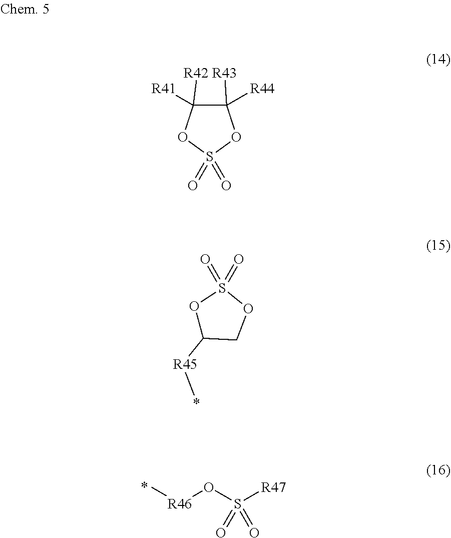

where:
each of R41 to R44 is one of a hydrogen group, an alkyl group, a halogenated alkyl group, a group represented by Formula (15), or a group represented by Formula (16);
at least one of R41 to R44 is one of the group represented by Formula (15) or the group represented by Formula (16);
each of R45 and R46 is one of an alkylene group or a halogenated alkylene group, or is omitted;
R47 is one of an alkyl group or a halogenated alkyl group; and
an asterisk (*) in each of Formula (15) and Formula (16) represents a bond.

A secondary battery according to an embodiment of the present technology includes a positive electrode, a negative electrode, and an electrolytic solution. The electrolytic solution has a configuration similar to the configuration of the electrolytic solution for a secondary battery according to an embodiment of the present technology described above.

According to the electrolytic solution for a secondary battery or the secondary battery of an embodiment of the present technology, the electrolytic solution for a secondary battery includes the diester compound and the sulfur-containing compound. Accordingly, it is possible to achieve a superior storage characteristic.

Note that effects of the present technology are not necessarily limited to those described above and may include any of a series of effects described below in relation to the present technology.

### BRIEF DESCRIPTION OF THE FIGURES

FIG. 1 is a perspective view of a configuration of a secondary battery according to an embodiment of the present technology.

FIG. 2 is a sectional view of a configuration of a battery device illustrated in FIG. 1.

FIG. 3 is a block diagram illustrating a configuration of an application example of the secondary battery.

### DETAILED DESCRIPTION

One or more embodiments of the present technology are described below in further detail including with reference to the drawings. Note that the description is given in the following order.

A description is given first of an electrolytic solution for a secondary battery (hereinafter simply referred to as an “electrolytic solution”) according to an embodiment of the present technology.

The electrolytic solution is to be used in a secondary battery. However, the electrolytic solution described here may be used in another electrochemical device other than a secondary battery. The other electrochemical device is not particularly limited in kind, and specific examples thereof include a capacitor.

The electrolytic solution includes a solvent, an electrolyte salt, a diester compound, and a sulfur-containing compound. The diester compound includes a compound represented by Formula (1), and the sulfur-containing compound includes one or more of respective compounds represented by Formulae (2) to (14).

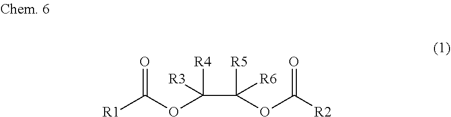

where:
each of R1 and R2 is one of a halogen group, an alkyl group, an alkoxy group, a halogenated alkyl group, or a halogenated alkoxy group; and
each of R3 to R6 is one of a hydrogen group, a halogen group, an alkyl group, or a halogenated alkyl group.

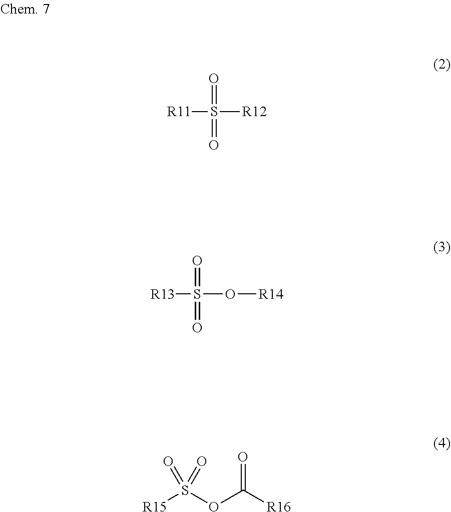

where:
each of R11 and R12 is one of an alkyl group, an alkenyl group, an aryl group, a halogenated alkyl group, a halogenated alkenyl group, or a halogenated aryl group,;
R11 and R12 are optionally bonded to each other;
R13 is one of an alkyl group, an aryl group, a hydroxyalkyl group, a lithium alkoxide group, a halogenated alkyl group, or a halogenated aryl group;
R14 is one of a hydrogen group, a lithium group, an alkyl group, or a halogenated alkyl group;
each of R15 and R16 is one of an alkyl group, an alkenyl group, an aryl group, a halogenated alkyl group, a halogenated alkenyl group, or a halogenated aryl group; and
R15 and R16 are optionally bonded to each other.

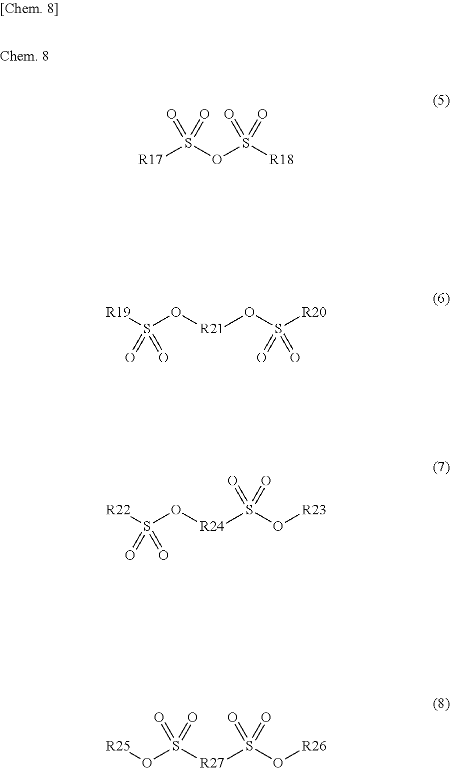

where:
each of R17 and R18 is one of an alkyl group, an alkenyl group, an aryl group, a halogenated alkyl group, a halogenated alkenyl group, or a halogenated aryl group;
R17 and R18 are optionally bonded to each other;
each of R19 and R20 is one of an alkyl group or a halogenated alkyl group;
R21 is one of an alkylene group or a halogenated alkylene group;
R22 is one of an alkyl group or a halogenated alkyl group;
R23 is one of a hydrogen group, a lithium group, an alkyl group, or a halogenated alkyl group;
R24 is one of an alkylene group or a halogenated alkylene group;
each of R25 and R26 is one of a hydrogen group, a lithium group, an alkyl group, or a halogenated alkyl group; and
R27 is one of an alkylene group or a halogenated alkylene group.

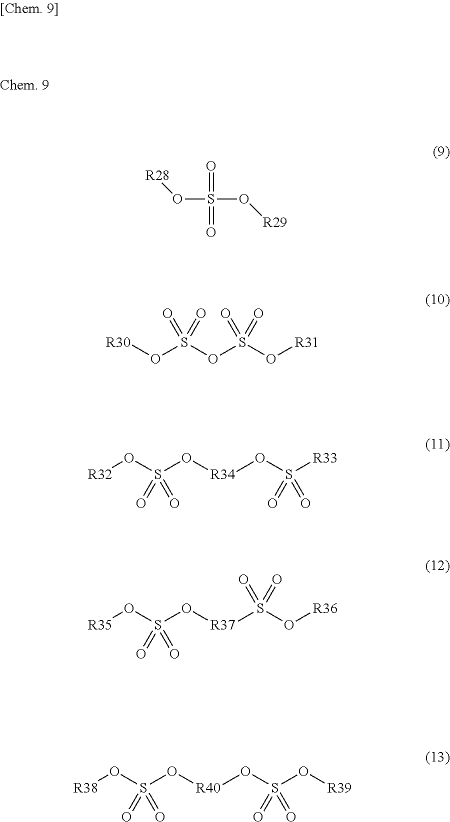

where:
each of R28 and R29 is one of a hydrogen group, a lithium group, an alkyl group, a hydroxyalkyl group, a lithium alkoxide group, or a halogenated alkyl group;
R28 and R29 are optionally bonded to each other;
1,2-ethylenesulfate and 1-methyl-1,2-ethylenesulfate are excluded from the sulfur-containing compound represented by Formula (9);
each of R30 and R31 is one of an alkyl group, an alkenyl group, an aryl group, a halogenated alkyl group, a halogenated alkenyl group, or a halogenated aryl group;
R30 and R31 are optionally bonded to each other;
R32 is one of a hydrogen group, a lithium group, an alkyl group, or a halogenated alkyl group;
R33 is one of an alkyl group or a halogenated alkyl group;
R34 is one of an alkylene group or a halogenated alkylene group;
each of R35 and R36 is one of a hydrogen group, a lithium group, an alkyl group, or a halogenated alkyl group;
R37 is one of an alkylene group or a halogenated alkylene group;
each of R38 and R39 is one of a hydrogen group, a lithium group, an alkyl group, or a halogenated alkyl group; and
R40 is one of an alkylene group or a halogenated alkylene group.

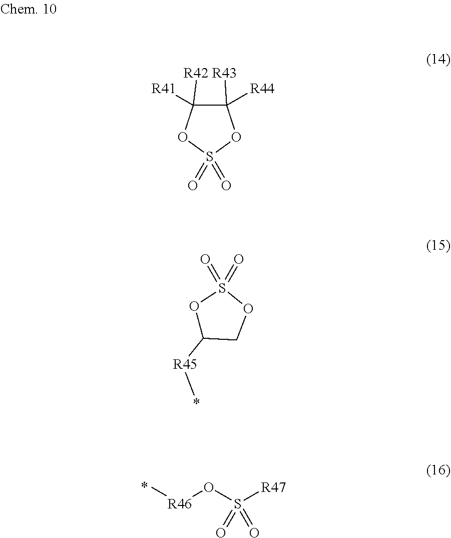

where:
each of R41 to R44 is one of a hydrogen group, an alkyl group, a halogenated alkyl group, a group represented by Formula (15), or a group represented by Formula (16);
at least one of R41 to R44 is one of the group represented by Formula (15) or the group represented by Formula (16);
each of R45 and R46 is one of an alkylene group or a halogenated alkylene group, or is omitted;
R47 is one of an alkyl group or a halogenated alkyl group; and
an asterisk (*) in each of Formula (15) and Formula (16) represents a bond.

A reason why the electrolytic solution includes the diester compound and the sulfur-containing compound together is that a quality film derived from both of the diester compound and the sulfur-containing compound is formed on a surface of an electrode upon charging and discharging of the secondary battery including the electrolytic solution. The surface of the electrode is thereby electrochemically protected, suppressing a decomposition reaction of the electrolytic solution on the surface of the electrode. In this case, the decomposition reaction of the electrolytic solution is effectively suppressed even if the secondary battery is stored in, in particular, a high-temperature environment.

As represented by Formula (1), the diester compound is a chain compound having two ester groups (R1—C(═O)—O— and R2—C(═O)—O—).

Each of R1 and R2 is not particularly limited as long as each of R1 and R2 is one of a halogen group, an alkyl group, an alkoxy group, a halogenated alkyl group, or a halogenated alkoxy group. R1 and R2 may be groups that are identical to each other, or may be groups that are different from each other.

The halogen group is not particularly limited in kind, and is specifically one of a fluorine group, a chlorine group, a bromine group, or an iodine group.

The alkyl group may have: a straight-chain structure; a branched structure having one or more side chains; a two-dimensional cyclic structure; or a three-dimensional crosslinked cyclic structure. The number of rings included in the alkyl group having a cyclic structure is not particularly limited, and may thus be only one or two or greater. Carbon number of the alkyl group is not particularly limited, and is preferably within a range from 1 to 4 both inclusive, more preferably, within a range from 1 to 3 both inclusive, in particular. A reason for this is that solubility and compatibility of the diester compound are secured. Specific examples of the alkyl group include a methyl group, an ethyl group, a propyl group, and a butyl group.

The alkoxy group may have: a straight-chain structure; or a branched structure having one or more side chains. Although not particularly limited, carbon number of the alkoxy group is preferably within a range from 1 to 4 both inclusive, more preferably, within a range from 1 to 3 both inclusive, in particular. A reason for this is that solubility and compatibility of the diester compound are secured. Specific examples of the alkoxy group include a methoxy group, an ethoxy group, a propoxy group, and a butoxy group.

The halogenated alkyl group is a group resulting from substituting one or more hydrogen groups of the alkyl group described above with one or more kinds of halogen groups. The halogenated alkoxy group is a group resulting from substituting one or more hydrogen groups of the alkoxy group described above with one or more kinds of halogen groups.

Each of R3 to R6 is not particularly limited as long as each of R3 to R6 is one of a hydrogen group, a halogen group, an alkyl group, or a halogenated alkyl group. R3 to R6 may be groups that are identical to each other, or may be groups that are different from each other. It goes without saying that only some of R3 to R6 may be groups that are identical to each other. Details of each of the halogen group, the alkyl group, and the halogenated alkyl group are as described above.

Specific examples of the diester compound include respective compounds represented by Formulae (1-1) to (1-46). A reason for this is that a film having sufficient electrochemical durability is easily formed on the surface of the electrode.

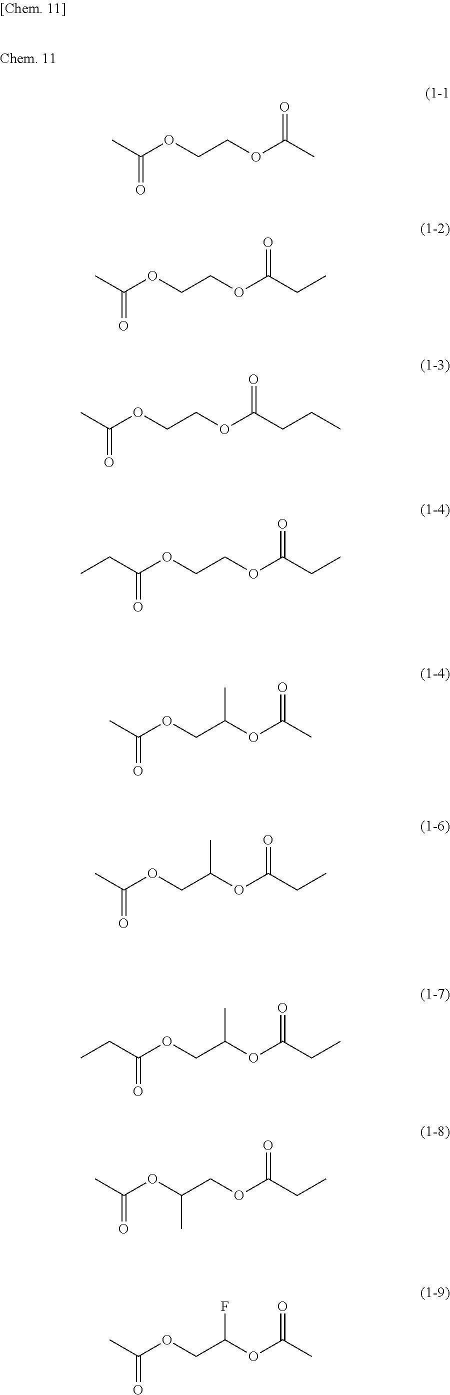

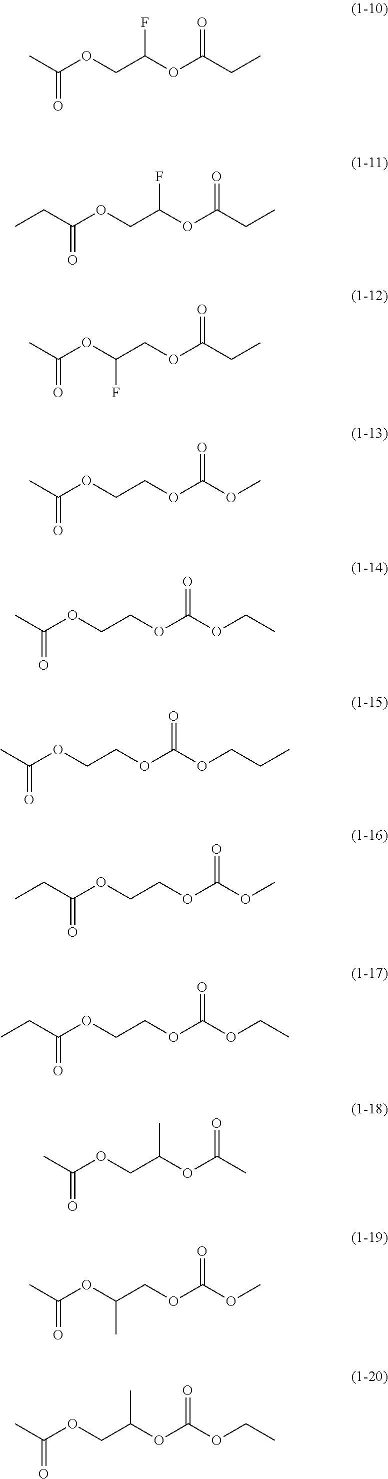

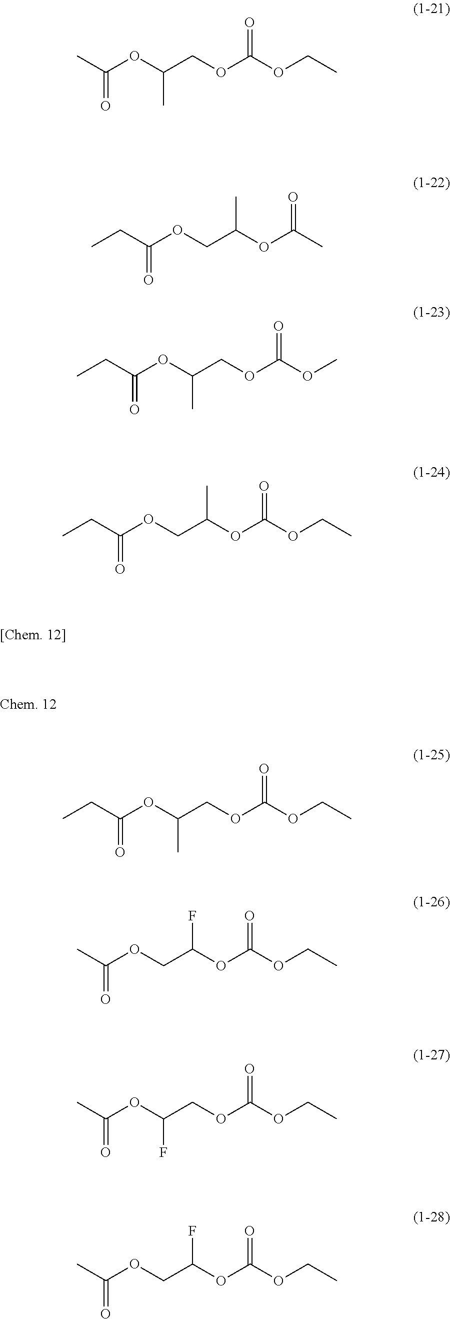

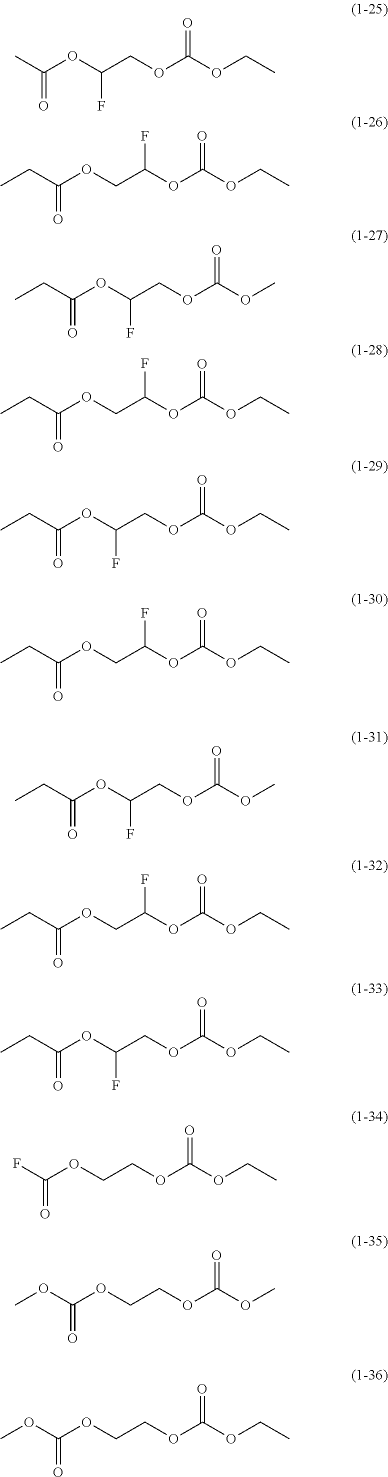

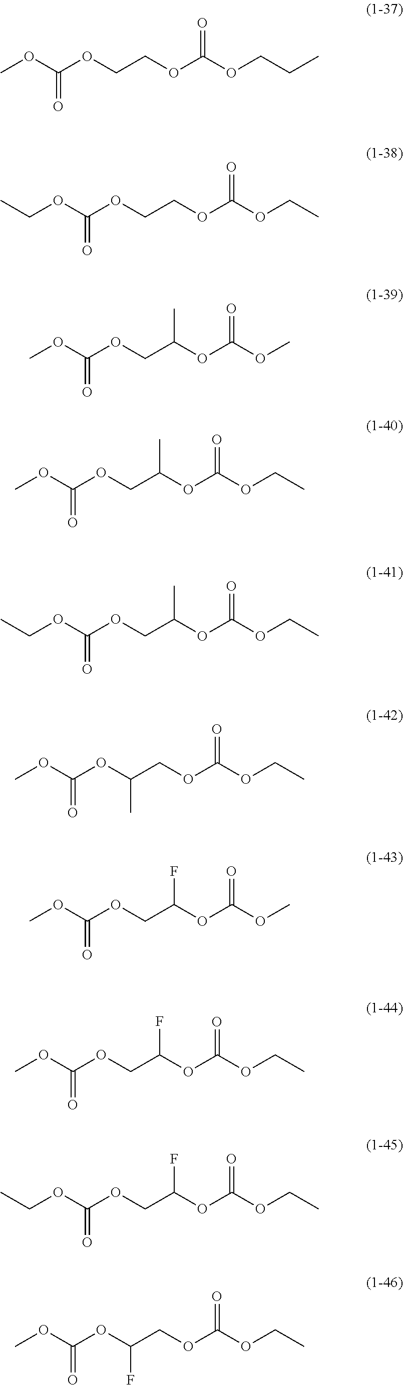

Although not particularly limited, a content of the diester compound in the electrolytic solution is preferably within a range from 0.001 wt % to 5 wt % both inclusive, in particular. A reason for this is that a film having sufficient electrochemical durability is easily formed on the surface of the electrode.

As represented by each of Formulae (2) to (14), the sulfur-containing compound is a chain or cyclic compound including sulfur as a constituent element.

Hereinafter, the compound represented by Formula (2) is referred to as a “first sulfur-containing compound”, the compound represented by Formula (3) is referred to as a “second sulfur-containing compound”, the compound represented by Formula (4) is referred to as a “third sulfur-containing compound”, the compound represented by Formula (5) is referred to as a “fourth sulfur-containing compound”, the compound represented by Formula (6) is referred to as a “fifth sulfur-containing compound”, the compound represented by Formula (7) is referred to as a “sixth sulfur-containing compound”, the compound represented by Formula (8) is referred to as a “seventh sulfur-containing compound”, the compound represented by Formula (9) is referred to as an “eighth sulfur-containing compound”, the compound represented by Formula (10) is referred to as a “ninth sulfur-containing compound”, the compound represented by Formula (11) is referred to as a “tenth sulfur-containing compound”, the compound represented by Formula (12) is referred to as an “eleventh sulfur-containing compound”, the compound represented by Formula (13) is referred to as a “twelfth sulfur-containing compound”, and the compound represented by Formula (14) is referred to as a “thirteenth sulfur-containing compound”.

As represented by Formula (2), the first sulfur-containing compound is a chain or cyclic compound having one sulphonyl group (—S(═O)₂—).

Each of R11 and R12 is not particularly limited as long as each of R11 and R12 is one of an alkyl group, an alkenyl group, an aryl group, a halogenated alkyl group, a halogenated alkenyl group, or a halogenated aryl group. R11 and R12 may be groups that are identical to each other, or may be groups that are different from each other. Details of each of the alkyl group and the halogenated alkyl group are as described above.

The alkenyl group may have: a straight-chain structure; or a branched structure having one or more side chains. Carbon number of the alkenyl group is preferably within a range from 2 to 4 both inclusive, more preferably, 2 or 3, in particular. A reason for this is that solubility and compatibility of the first sulfur-containing compound are secured. Specific examples of the alkenyl group include a vinyl group and an allyl group.

The number of aromatic rings included in the aryl group is not particularly limited. Accordingly, carbon number of the aryl group is not particularly limited, and is preferably within a range from 6 to 10 both inclusive, more preferably, 6, in particular. A reason for this is that solubility and compatibility of the first sulfur-containing compound are secured. Specific examples of the aryl group include a phenyl group, a tolyl group, and a naphthyl group.

The halogenated alkenyl group is a group resulting from substituting one or more hydrogen groups of the alkenyl group described above with one or more kinds of halogen groups. The halogenated aryl group is a group resulting from substituting one or more hydrogen groups of the aryl group described above with one or more kinds of halogen groups.

Note that R11 and R12 may be bonded to each other. That is, as described above, the first sulfur-containing compound may be a chain compound in which R11 and R12 are not bonded to each other, or may be a cyclic compound in which R11 and R12 are bonded to each other.

As represented by Formula (3), the second sulfur-containing compound is a chain compound having one sulfurous acid group (—S(═O)₂—O—).

R13 is not particularly limited as long as R13 is one of an alkyl group, an aryl group, a hydroxyalkyl group, a lithium alkoxide group, a halogenated alkyl group, or a halogenated aryl group. Details of each of the alkyl group, the aryl group, the halogenated alkyl group, and the halogenated aryl group are as described above.

The hydroxyalkyl group is a group resulting from substituting one or more hydrogen groups of the alkyl group described above with one or more hydroxyl groups. The hydroxyl group may be introduced at a terminal of the alkyl group, or may be introduced in the middle of the alkyl group. Although not particularly limited, carbon number of the hydroxyalkyl group is preferably within a range from 1 to 4 both inclusive, more preferably, within a range from 1 to 3 both inclusive, in particular. A reason for this is that solubility and compatibility of the second sulfur-containing compound are secured. Specific examples of the hydroxyalkyl group include a hydroxymethyl group (—CH₂—OH), a hydroxyethyl group (—C₂H₄—OH), a hydroxypropyl group (—C₃H₆—OH), and hydroxybutyl group (—C₄H₈—OH).

The lithium alkoxide group is a group resulting from substituting a hydrogen group of the hydroxyl group included in the hydroxyalkyl group described above with a lithium group. Specific examples of the lithium alkoxide group include a lithium methoxide group (—CH₂—OLi), a lithium ethoxide group (—C₂H₄—OLi), a lithium propoxide group (—C₃H₆—OLi), and a lithium butoxide group (—C₄H₈—OLi).

R14 is not particularly limited as long as R14 is one of a hydrogen group, a lithium group, an alkyl group, or a halogenated alkyl group. Details of each of the alkyl group and the halogenated alkyl group are as described above.

As represented by Formula (4), the third sulfur-containing compound is a chain or cyclic compound having one sulfocarboxylic acid group (—S(═O)₂—O—C(═O)—).

Each of R15 and R16 is not particularly limited as long as each of R15 and R16 is one of an alkyl group, an alkenyl group, an aryl group, a halogenated alkyl group, a halogenated alkenyl group, or a halogenated aryl group. R15 and

R16 may be groups that are identical to each other, or may be groups that are different from each other. Details of each of the alkyl group, the alkenyl group, the aryl group, the halogenated alkyl group, the halogenated alkenyl group, and the halogenated aryl group are as described above.

Note that R15 and R16 may be bonded to each other. That is, as described above, the third sulfur-containing compound may be a chain compound in which R15 and R16 are not bonded to each other, or may be a cyclic compound in which R15 and R16 are bonded to each other.

As represented by Formula (5), the fourth sulfur-containing compound is a chain or cyclic compound having two sulphonyl groups (—S(═O)₂—) that are bonded to each other via an ether bond (—O—).

Each of R17 and R18 is not particularly limited as long as each of R17 and R18 is one of an alkyl group, an alkenyl group, an aryl group, a halogenated alkyl group, a halogenated alkenyl group, or a halogenated aryl group. R17 and R18 may be groups that are identical to each other, or may be groups different from each other. Details of each of the alkyl group, the alkenyl group, the aryl group, the halogenated alkyl group, the halogenated alkenyl group, and the halogenated aryl group are as described above.

Note that R17 and R18 may be bonded to each other. That is, as described above, the fourth sulfur-containing compound may be a chain compound in which R17 and R18 are not bonded to each other, or may be a cyclic compound in which R17 and R18 are bonded to each other.

As represented by Formula (6), the fifth sulfur-containing compound is a chain compound having two sulfurous acid groups that are bonded to each other via a linking group (—R21-). In the fifth sulfur-containing compound, the two sulfurous acid groups described above are arranged in a bilaterally symmetric configuration.

Each of R19 and R20 is not particularly limited as long as each of R19 and R20 is one of an alkyl group or a halogenated alkyl group. R19 and R20 may be groups that are identical to each other, or may be groups different from each other. Details of each of the alkyl group and the halogenated alkyl group are as described above.

R21 is not particularly limited as long as R21 is one of an alkylene group or a halogenated alkylene group.

The alkylene group may have: a straight-chain structure; or a branched structure having one or more side chains. Although not particularly limited, carbon number of the alkylene group is preferably within a range from 1 to 4 both inclusive, more preferably, within a range from 1 to 3 both inclusive, in particular. A reason for this is that solubility and compatibility of the fifth sulfur-containing compound are secured. Specific examples of the alkylene group include a methylene group, an ethylene group, a propylene group, and a butylene group.

The halogenated alkylene group is a group resulting from substituting one or more hydrogen groups of the alkylene group described above with one or more kinds of halogen groups.

As represented by Formula (7), the sixth sulfur-containing compound is a chain compound having two sulfurous acid groups that are bonded to each other via a linking group (—R24-). In the sixth sulfur-containing compound, the two sulfurous acid groups described above are arranged in a bilaterally symmetric configuration.

R22 is not particularly limited as long as R22 is one of an alkyl group or a halogenated alkyl group, and R23 is not particularly limited as long as R23 is one of a hydrogen group, a lithium group, an alkyl group, or a halogenated alkyl group. Details of each of the alkyl group and the halogenated alkyl group are as described above.

R24 is not particularly limited as long as R24 is one of an alkylene group or a halogenated alkylene group. Details of each of the alkylene group and the halogenated alkylene group are as described above.

As represented by Formula (8), the seventh sulfur-containing compound is a chain compound having two sulfurous acid groups that are bonded to each other via a linking group (—R27-). In the seventh sulfur-containing compound, the two sulfurous acid groups described above are arranged in a bilaterally symmetric configuration.

Each of R25 and R26 is not particularly limited as long as each of R25 and R26 is one of a hydrogen group, a lithium group, an alkyl group, or a halogenated alkyl group. R25 and R26 may be groups that are identical to each other, or may be groups that are different from each other. Details of each of the alkyl group and the halogenated alkyl group are as described above.

R27 is not particularly limited as long as R27 is one of an alkylene group or a halogenated alkylene group. Details of each of the alkylene group and the halogenated alkylene group are as described above.

As represented by Formula (9), the eighth sulfur-containing compound is a chain or cyclic compound having one sulfuric acid group (—O—S(═O)₂—O—).

Each of R28 and R29 is not particularly limited as long as each of R28 and R29 is one of a hydrogen group, a lithium group, an alkyl group, a hydroxyalkyl group, a lithium alkoxide group, or a halogenated alkyl group. R28 and R29 may be groups that are identical to each other, or may be groups that are different from each other. Details of each of the alkyl group, the hydroxyalkyl group, the lithium alkoxide group, and the halogenated alkyl group are as described above.

Note that R28 and R29 may be bonded to each other. That is, as described above, the eighth sulfur-containing compound may be a chain compound in which R28 and R29 are not bonded to each other, or may be a cyclic compound in which R28 and R29 are bonded to each other.

Here, among a series of compounds each having a structure represented by Formula (9), 1,2-ethylene sulfate and 1-methyl-1,2-ethylene sulfate are excluded from the eighth sulfur-containing compound. That is, neither 1,2-ethylene sulfate nor 1-methyl-1,2-ethylene sulfate corresponds to the eighth sulfur-containing compound described here even if it has the structure represented by Formula (9). A reason for this is that a quality film is prevented from being easily formed on the surface of the electrode, making it difficult to electrochemically protect the surface of the electrode.

As represented by Formula (10), the ninth sulfur-containing compound is a chain or cyclic compound having two sulfurous acid groups that are bonded to each other via an ether bond. In the ninth sulfur-containing compound, the two sulfurous acid groups are arranged in a bilaterally symmetric configuration.

Each of R30 and R31 is not particularly limited as long as each of R30 and R31 is one of an alkyl group, an alkenyl group, an aryl group, a halogenated alkyl group, a halogenated alkenyl group, or a halogenated aryl group. R30 and R31 may be groups that are identical to each other, or may be groups that are different from each other. Details of each of the alkyl group, the alkenyl group, the aryl group, the halogenated alkyl group, the halogenated alkenyl group, and the halogenated aryl group are as described above.

Note that R30 and R31 may be bonded to each other. That is, as described above, the ninth sulfur-containing compound may be a chain compound in which R30 and R31 are not bonded to each other, or may be a cyclic compound in which R30 and R31 are bonded to each other.

As represented by Formula (11), the tenth sulfur-containing compound is a chain compound having one sulfuric acid group and one sulfurous acid group that are bonded to each other via a linking group (—R34).

R32 is not particularly limited as long as R32 is one of a hydrogen group, a lithium group, an alkyl group, or a halogenated alkyl group, and R33 is not particularly limited as long as R33 is one of an alkyl group or a halogenated alkyl group. Details of each of the alkyl group and the halogenated alkyl group are as described above.

R34 is not particularly limited as long as R34 is one of an alkylene group or a halogenated alkylene group. Details of each of the alkylene group and the halogenated alkylene group are as described above.

As represented by Formula (12), the eleventh sulfur-containing compound is a chain compound having one sulfuric acid group and one sulfurous acid group that are bonded to each other via a linking group (—R37).

Each of R35 and R36 is not particularly limited as long as each of R35 and R36 is one of a hydrogen group, a lithium group, an alkyl group, or a halogenated alkyl group. R35 and R36 may be groups that are identical to each other, or may be groups that are different from each other. Details of each of the alkyl group and the halogenated alkyl group are as described above.

R37 is not particularly limited as long as R37 is one of an alkylene group or a halogenated alkylene group. Details of each of the alkylene group and the halogenated alkylene group are as described above.

As represented by Formula (13), the twelfth sulfur-containing compound is a chain compound having two sulfuric acid groups that are bonded to each other via a linking group (—R40-).

Each of R38 and R39 is not particularly limited as long as each of R38 and R39 is one of a hydrogen group, a lithium group, an alkyl group, or a halogenated alkyl group. R38 and R39 may be groups that are identical to each other, or may be groups that are different from each other. Details of each of the alkyl group and the halogenated alkyl group are as described above.

R40 is not particularly limited as long as R40 is one of an alkylene group or a halogenated alkylene group. Details of each of the alkylene group and the halogenated alkylene group are as described above.

As represented by Formula (14), the thirteenth sulfur-containing compound is a cyclic compound having one sulfuric acid group.

Each of R41 to R44 is not particularly limited as long as each of R41 to R45 is one of a hydrogen group, an alkyl group, a halogenated alkyl group, a group represented by Formula (15), or a group represented by Formula (16). R41 to R44 may be groups that are identical to each other, or may be groups that are different from each other. It goes without saying that only some of R41 to R44 may be groups that are identical to each other. Details of each of the alkyl group and the halogenated alkyl group are as described above.

The group represented by Formula (15) is a cyclic group having a 1,2-ethylene sulfate structure, where an asterisk (*) in Formula (15) represents a bond. Thus, the group represented by Formula (15) may be any of R41 to R44 in Formula (14).

R45 is not particularly limited as long as R45 is one of an alkylene group or a halogenated alkylene group. Details of each of the alkylene group and the halogenated alkylene group are as described above. Note that R45 may be omitted.

The group represented by Formula (16) is a chain group having one sulfurous acid group, where an asterisk (*) in Formula (16) represents a bond. Thus, the group represented by Formula (16) may be any of R41 to R44 in Formula (14).

R46 is not particularly limited as long as R46 is one of an alkylene group or a halogenated alkylene group. Details of each of the alkylene group and the halogenated alkylene group are as described above. Note that R46 may be omitted as in the case of R45 described above.

R47 is not particularly limited as long as R47 is one of an alkyl group or a halogenated alkyl group. Details of each of the alkyl group and the halogenated alkyl group are as described above.

Here, one or more of R41 to R44 are each the group represented by Formula (15) or the group represented by Formula (16). Accordingly, the thirteenth sulfur-containing compound includes the group represented by Formula (15), the group represented by Formula (16), or both, and is thus different from the eighth sulfur-containing compound that is a cyclic compound.

Specific examples of each of the first to thirteenth sulfur-containing compounds are as follows. A reason for this is that a film having sufficient electrochemical durability is easily formed on the surface of the electrode.

Specific examples of the first sulfur-containing compound include respective compounds represented by Formulae (2-1) to (2-7).

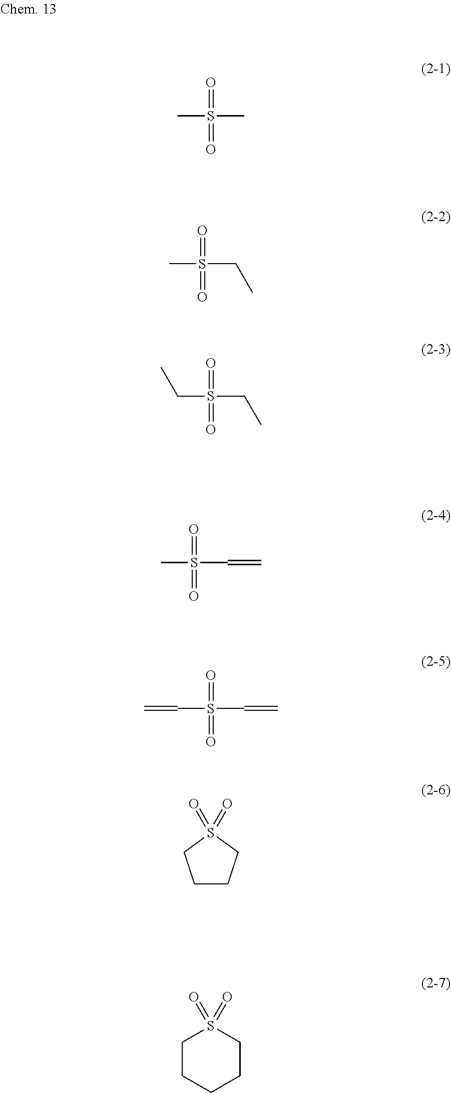

Specific examples of the second sulfur-containing compound include respective compounds represented by Formulae (3-1) to (3-10).

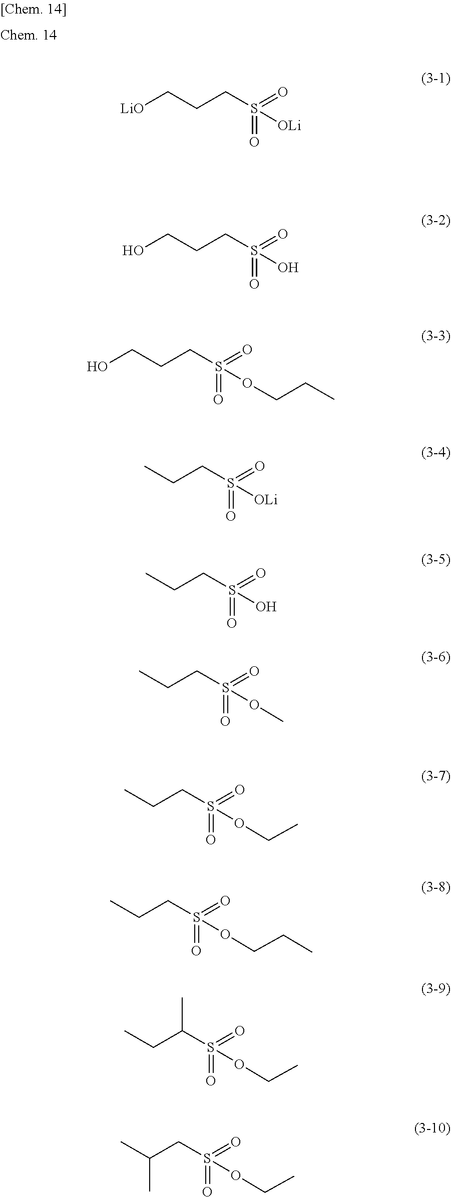

Specific examples of the third sulfur-containing compound include respective compounds represented by Formulae (4-1) to (4-18).

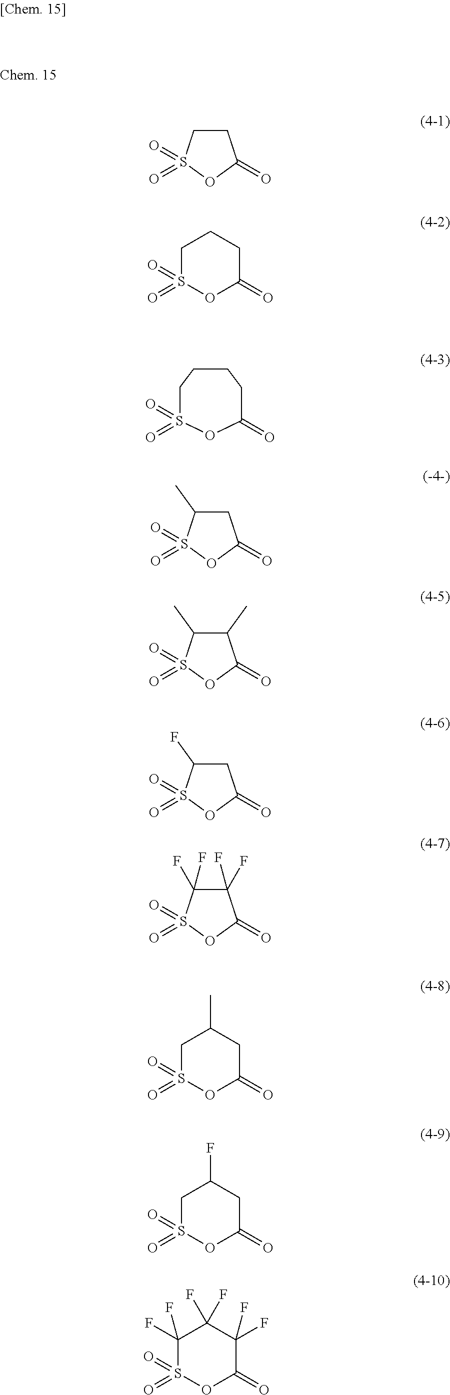

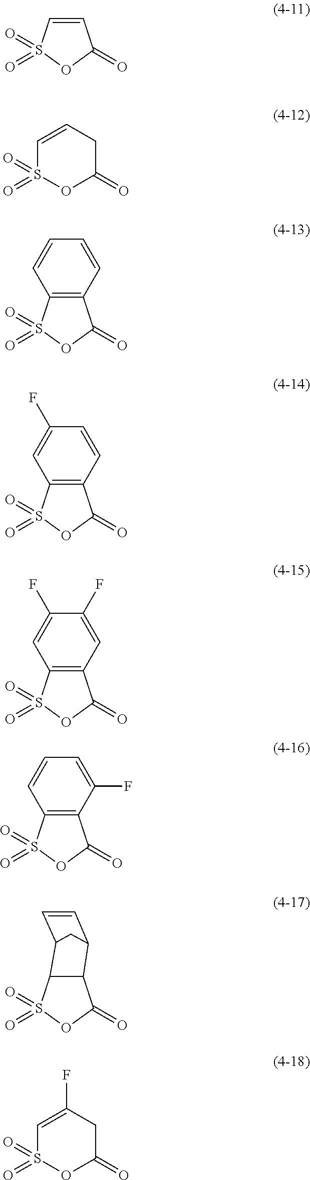

Specific examples of the fourth sulfur-containing compound include respective compounds represented by Formulae (5-1) to (5-17).

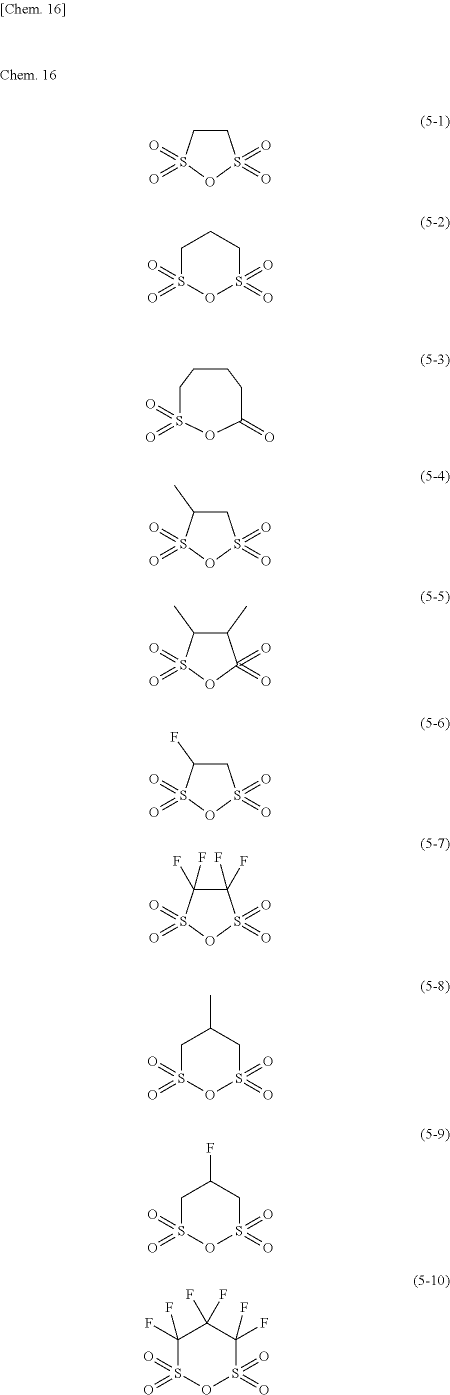

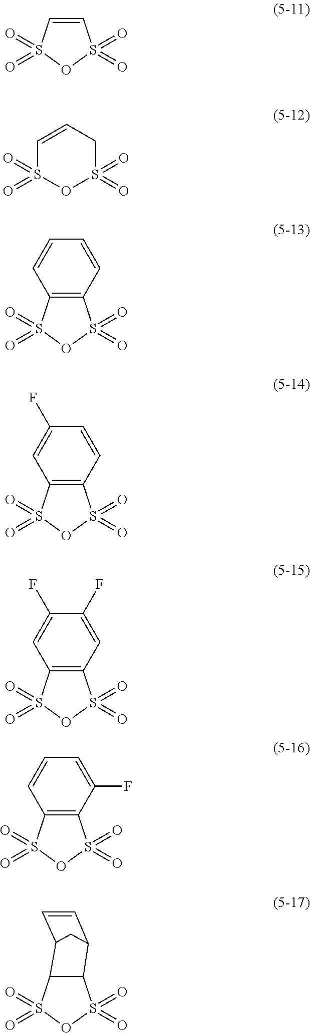

Specific examples of the fifth sulfur-containing compound include respective compounds represented by Formulae (6-1) to (6-8).

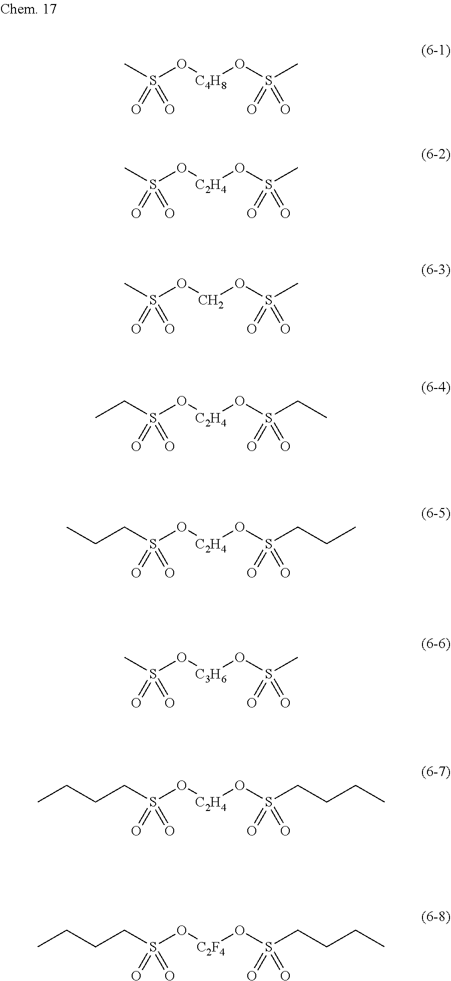

Specific examples of the sixth sulfur-containing compound include respective compounds represented by Formulae (7-1) to (7-10).

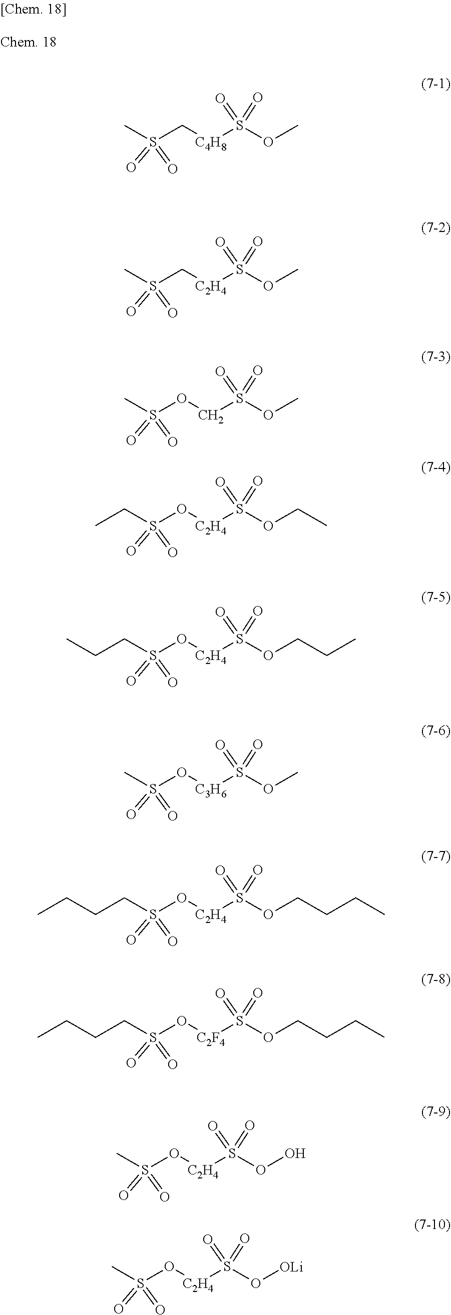

Specific examples of the seventh sulfur-containing compound include respective compounds represented by Formulae (8-1) to (8-10).

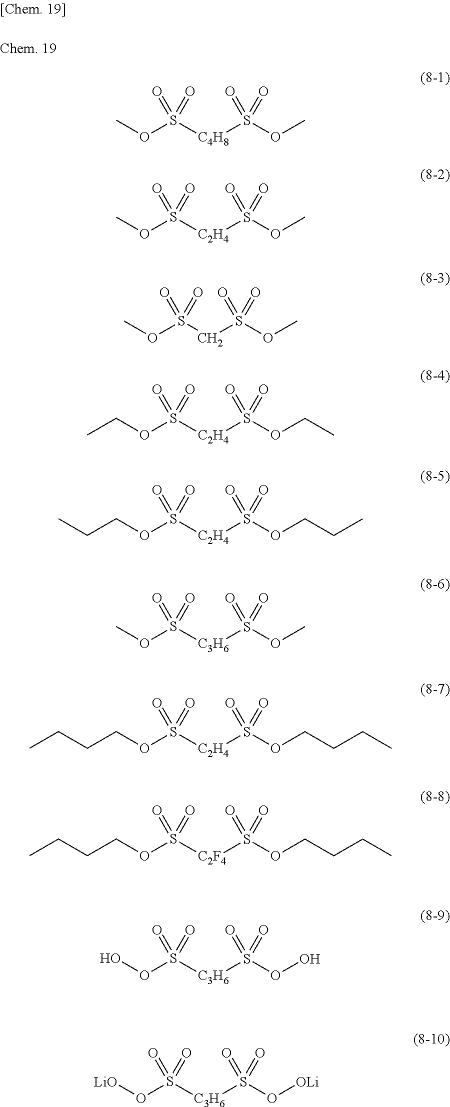

Specific examples of the eighth sulfur-containing compound include respective compounds represented by Formulae (9-1) to (9-20).

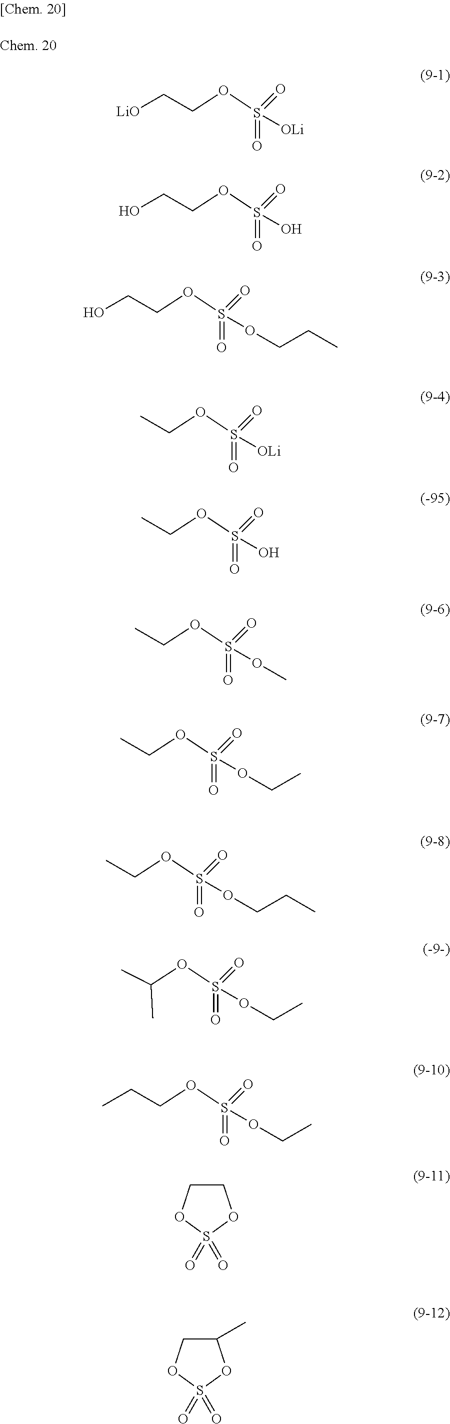

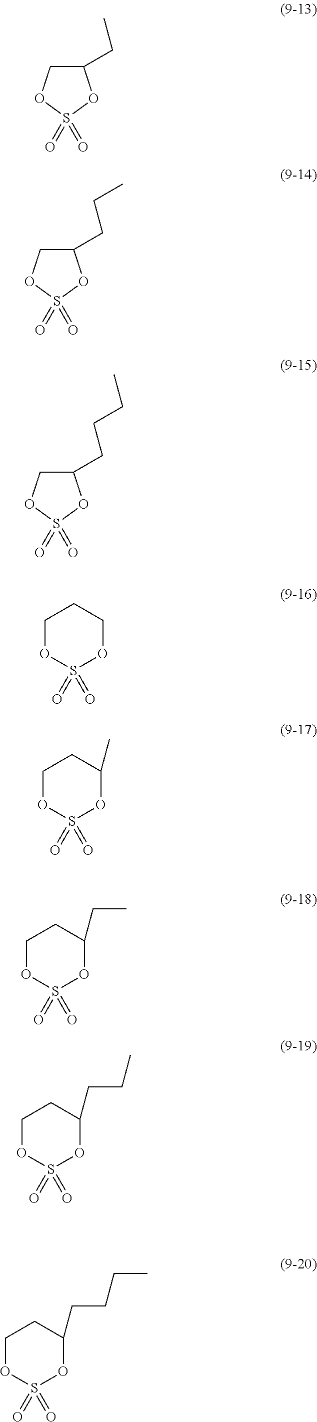

Specific examples of the ninth sulfur-containing compound include respective compounds represented by Formulae (10-1) to (10-13).

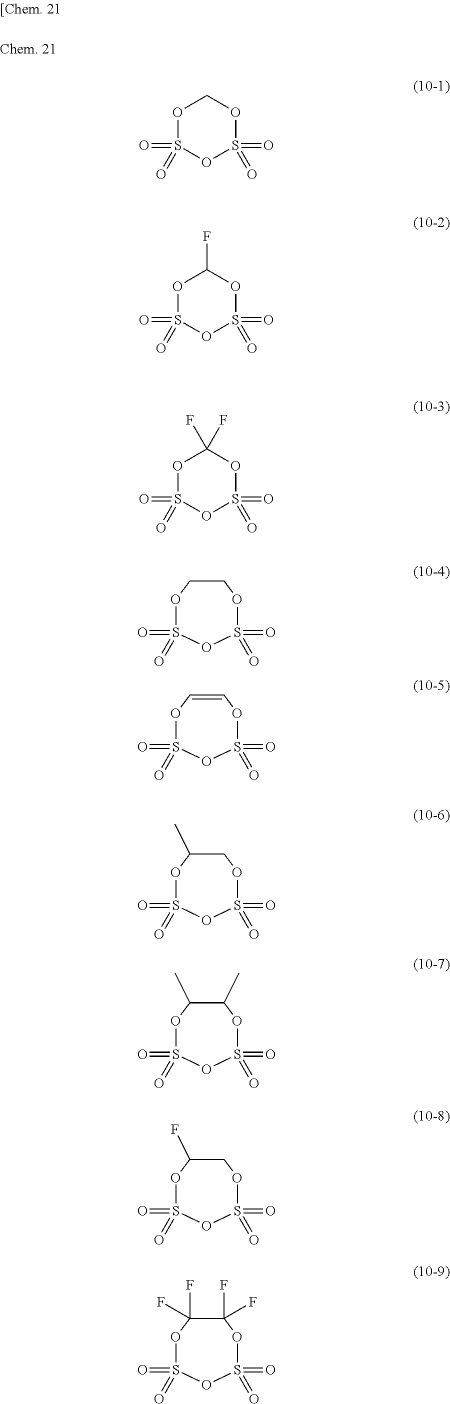

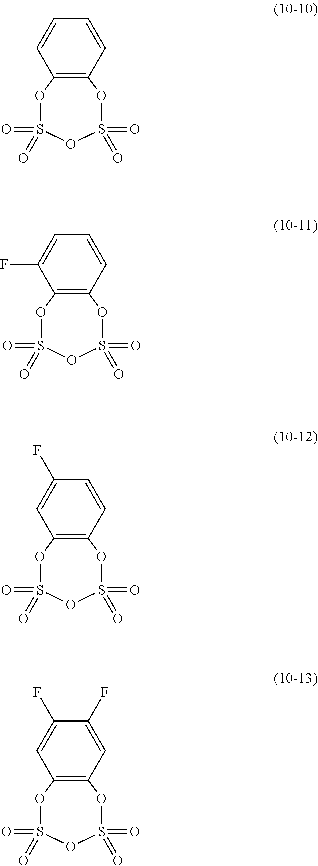 [SMILES: O=S1(=O)Oc2ccccc2OS(=O)(=O)O1 ; O=S1(=O)Oc2cccc(F)c2OS(=O)(=O)O1 ; O=S1(=O)Oc2ccc(F)cc2OS(=O)(=O)O1 ; O=S1(=O)Oc2cc(F)c(F)cc2OS(=O)(=O)O1]

Specific examples of the tenth sulfur-containing compound include respective compounds represented by Formulae (11-1) to (11-10).

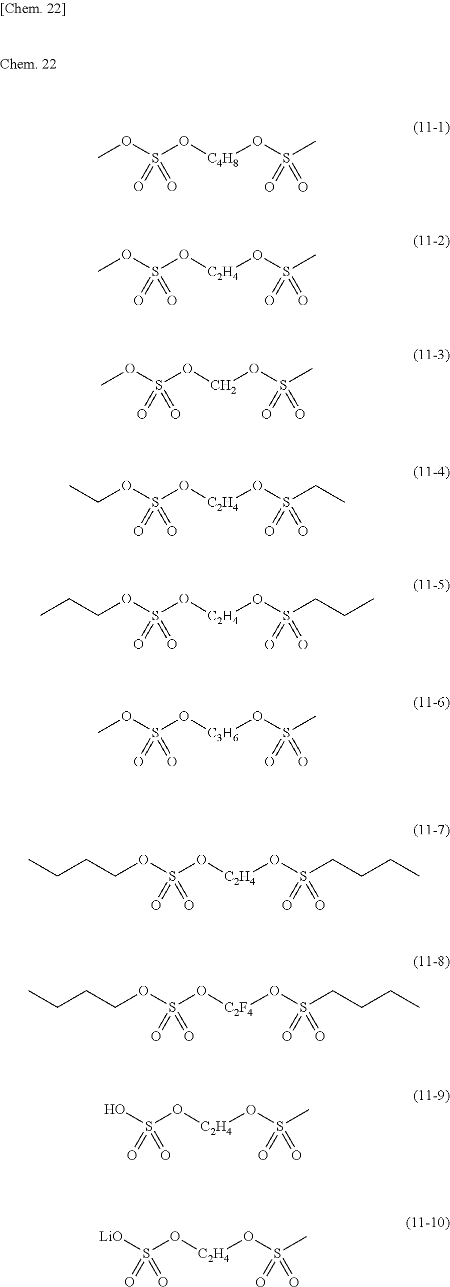

Specific examples of the eleventh sulfur-containing compound include respective compounds represented by Formulae (12-1) to (12-10).

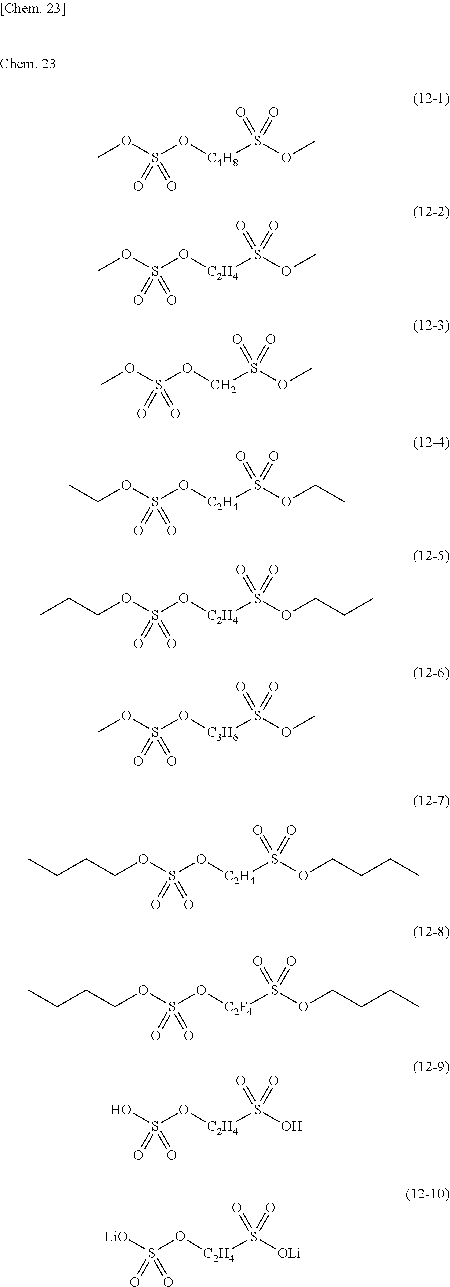

Specific examples of the twelfth sulfur-containing compound include respective compounds represented by Formulae (13-1) to (13-10).

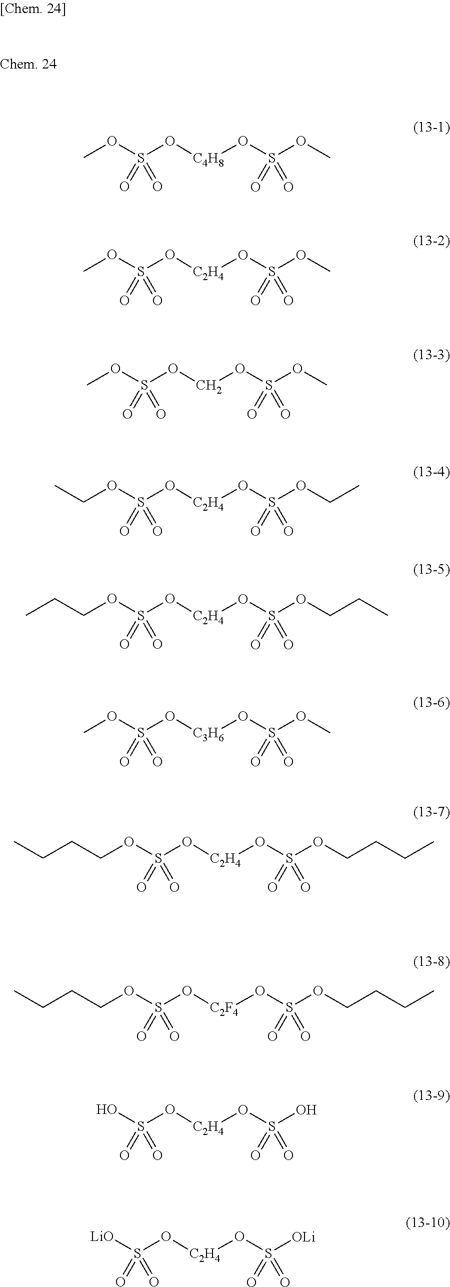

Specific examples of the thirteenth sulfur-containing compound include respective compounds represented by Formulae (14-1) to (14-3).

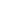

Although not particularly limited, a content of the sulfur-containing compound in the electrolytic solution is preferably within a range from 0.001 wt % to 5 wt % both inclusive, in particular. A reason for this is that a film having sufficient electrochemical durability is easily formed on the surface of the electrode.

Note that, in a case where the electrolytic solution includes two or more sulfur-containing compounds, the content described here is a sum of contents of the sulfur-containing compounds in the electrolytic solution.

The solvent includes one or more of non-aqueous solvents (organic solvents), and the electrolytic solution including the non-aqueous solvent(s) is a so-called non-aqueous electrolytic solution. The non-aqueous solvent is, for example, an ester or an ether, more specifically, a carbonic-acid-ester-based compound, a carboxylic-acid-ester-based compound, or a lactone-based compound, for example.

The carbonic-acid-ester-based compound is a cyclic carbonic acid ester or a chain carbonic acid ester, for example. Specific examples of the cyclic carbonic acid ester include ethylene carbonate and propylene carbonate, and specific examples of the chain carbonic acid ester include dimethyl carbonate, diethyl carbonate, and ethyl methyl carbonate.

The carboxylic-acid-ester-based compound is a chain carboxylic acid ester, for example. Specific examples of the chain carboxylic acid ester include methyl acetate, ethyl acetate, methyl propionate, ethyl propionate, propyl propionate, and ethyl trimethylacetate.

The lactone-based compound is a lactone, for example. Specific examples of the lactone include γ-butyrolactone and γ-valerolactone.

Note that the ether may be the lactone-based compound described above, 1,2-dimethoxyethane, tetrahydrofuran, 1,3-dioxolane, or 1,4-dioxane, for example.

The electrolyte salt is a light metal salt such as a lithium salt. Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), lithium bis(oxalato)borate (LiB(C₂O₄)₂), and lithium difluoro(oxalato)borate (LiB(C₂O₄)F₂).

A content of the electrolyte salt is not particularly limited, and is specifically within a range from 0.3 mol/kg to 3.0 mol/kg both inclusive with respect to the solvent. A reason for this is that high ion conductivity is obtainable.

Note that the electrode solution may further include one or more of additives. The additives are not particularly limited in kind, and specific examples thereof include an unsaturated cyclic carbonic acid ester, a halogenated carbonic acid ester, a phosphoric acid ester, an acid anhydride, a nitrile compound, and an isocyanate compound. A reason for this is that chemical stability of the electrolytic solution improves. Note that the sulfur-containing compounds described above are excluded from the acid anhydride described here.

Specific examples of the unsaturated cyclic carbonic acid ester include vinylene carbonate (1,3-dioxol-2-one), vinylethylene carbonate (4-vinyl-1,3-dioxolane-2-one), and methylene ethylene carbonate (4-methylene-1,3-dioxolane-2-one).

Specific examples of the halogenated carbonic acid ester include fluoroethylene carbonate (4-fluoro-1,3-dioxolane-2-one) and difluoroethylene carbonate (4,5-difluoro-1,3-dioxolane-2-one).

Specific examples of the phosphoric acid ester include trimethyl phosphate and triethyl phosphate.

The acid anhydride is a cyclic dicarboxylic acid anhydride, for example, and specific examples of the cyclic dicarboxylic acid anhydride include succinic anhydride, glutaric anhydride, and maleic anhydride.

Specific examples of the nitrile compound include acetonitrile, succinonitrile, and adiponitrile.

Specific examples of the isocyanate compound include hexamethylene diisocyanate.

In a case of manufacturing the electrolytic solution, the electrolyte salt is added to the solvent, following which the diester compound and the sulfur-containing compound are added to the solvent. The electrolyte salt, the diester compound, and the sulfur-containing compound are thereby each dispersed or dissolved in the solvent. As a result, the electrolytic solution is prepared.

According to the electrolytic solution, the diester compound and the sulfur-containing compound are included together.

In this case, as compared with a case where the electrolytic solution includes neither the diester compound nor the sulfur-containing compound and a case where the electrolytic solution includes the diester compound and another compound, a film derived from both of the diester compound and the sulfur-containing compound is formed on the surface of the electrode in the secondary battery using the electrolytic solution, which electrochemically protects the surface of the electrode.

The other compound described here includes propane sultone represented by Formula (17-1), propene sultone represented by Formula (17-2), glycol sulphate (1,2-ethylene sulphate) represented by Formula (17-3), and propylene glycol sulphate (1-methyl-1,2-ethylene sulphate) represented by Formula (17-4).

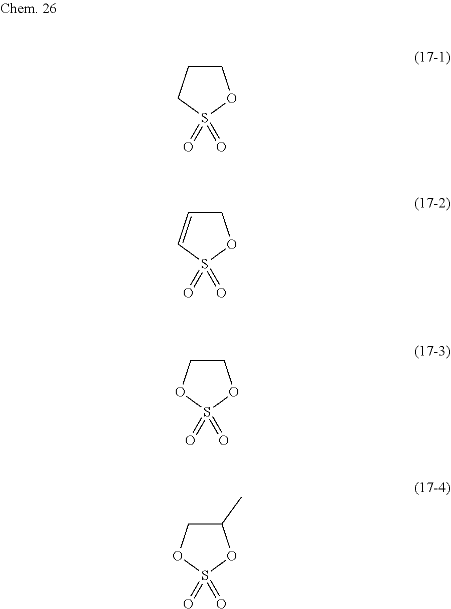

Accordingly, a decomposition reaction of the electrolytic solution is effectively suppressed even if the secondary battery is stored in a high-temperature environment. This helps to prevent a discharging capacity of the secondary battery from decreasing easily. It is thus possible to achieve a superior storage characteristic.

In particular, carbon number of, for example, the alkyl group may be within a range from 1 to 4 both inclusive, carbon number of, for example, the alkenyl group may be within a range from 2 to 4 both inclusive, carbon number of, for example, the aryl group may be within a range from 6 to 10 both inclusive, and carbon number of, for example, the alkylene group may be within a range from 1 to 4 both inclusive. In this case, solubility and compatibility of each of the diester compound and the sulfur-containing compound are secured. It is thus possible to achieve higher effects.

Further, the content of the diester compound in the electrolytic solution may be within a range from 0.001 wt % to 5 wt % both inclusive. In this case, a film having sufficient electrochemical durability is easily formed on the surface of the electrode. It is thus possible to achieve higher effects.

Further, the content of the sulfur-containing compound in the electrolytic solution may be within a range from 0.001 wt % to 5 wt % both inclusive. In this case, a film having sufficient electrochemical durability is easily formed on the surface of the electrode. It is thus possible to achieve higher effects.

A description is given next of a secondary battery including the electrolytic solution described above.

The secondary battery to be described here is a secondary battery that obtains a battery capacity using insertion and extraction of an electrode reactant, and includes a positive electrode, a negative electrode, and an electrolytic solution which is a liquid electrolyte. In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is set to be greater than an electrochemical capacity per unit area of the positive electrode.

The electrode reactant is not particularly limited in kind, and specific examples thereof include a light metal such as an alkali metal or an alkaline earth metal. Examples of the alkali metal include lithium, sodium, and potassium. Examples of the alkaline earth metal include beryllium, magnesium, and calcium.

Examples are given below of a case where the electrode reactant is lithium. A secondary battery that obtains a battery capacity using insertion and extraction of lithium is a so-called lithium-ion secondary battery. In the lithium-ion secondary battery, lithium is inserted and extracted in an ionic state.

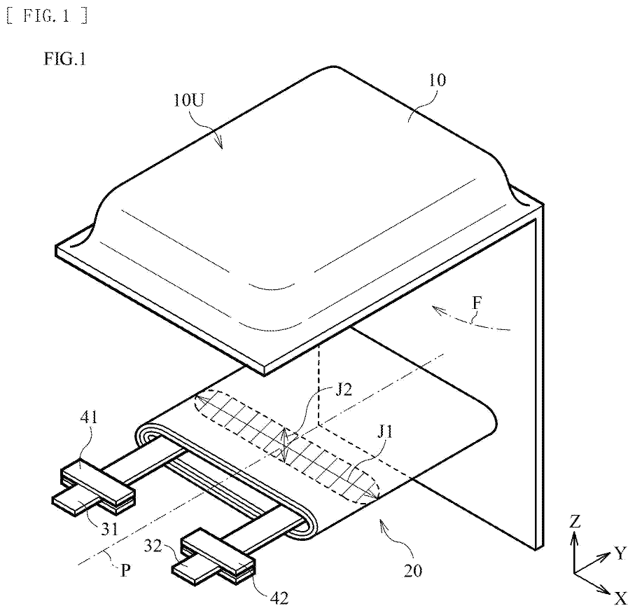

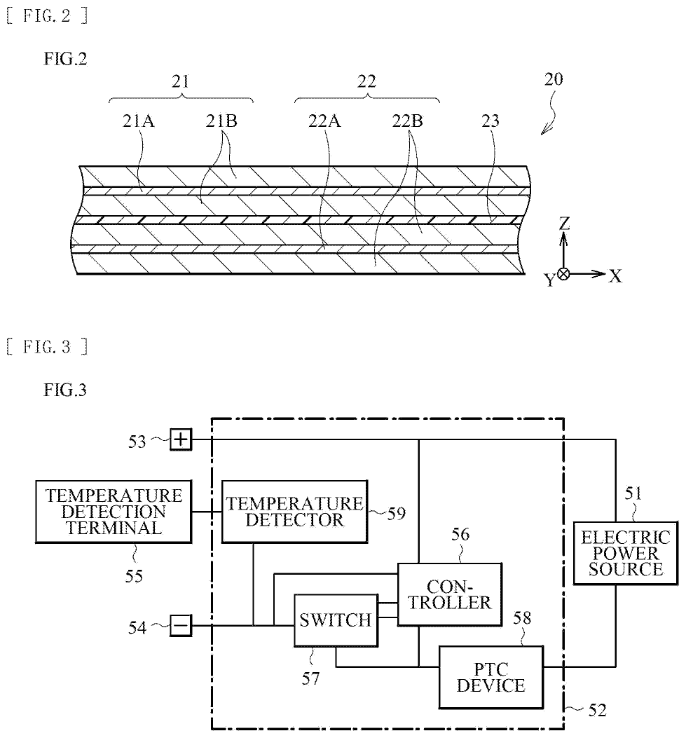

FIG. 1 illustrates a perspective configuration of the secondary battery. FIG. 2 illustrates a sectional configuration of a battery device 20 illustrated in FIG. 1. Note that FIG. 1 illustrates a state in which an outer package film 10 and the battery device 20 are separated away from each other, and a section of the battery device 20 along an XZ plane by a dashed line. FIG. 2 illustrates only a portion of the battery device 20.

As illustrated in FIGS. 1 and 2, the secondary battery includes the outer package film 10, the battery device 20, a positive electrode lead 31, a negative electrode lead 32, and sealing films 41 and 42. The secondary battery described here is a secondary battery of a laminated-film type in which the outer package film 10 having flexibility or softness is used.

As illustrated in FIG. 1, the outer package film 10 is a flexible outer package member that contains the battery device 20. The outer package film 10 has a pouch-shaped structure in which the battery device 20 is sealed in a state of being contained inside the outer package film 10. The outer package film 10 thus contains a positive electrode 21, a negative electrode 22, and an electrolytic solution that are to be described later.

Here, the outer package film 10 is a single film-shaped member and is foldable toward a folding direction F. The outer package film 10 has a depression part 10U to place the battery device 20 therein. The depression part 10U is a so-called deep drawn part.

Specifically, the outer package film 10 is a three-layered laminated film including a fusion-bonding layer, a metal layer, and a surface protective layer that are stacked in this order from an inner side. In a state in which the outer package film 10 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 10 is not particularly limited in configuration or the number of layers, and may be single-layered or two-layered, or may include four or more layers.

The sealing film 41 is interposed between the outer package film 10 and the positive electrode lead 31. The sealing film 42 is interposed between the outer package film 10 and the negative electrode lead 32. Note that the sealing film 41, the sealing film 42, or both may be omitted.

The sealing film 41 is a sealing member that prevents entry, for example, of outside air into the outer package film 10. The sealing film 41 includes a polymer compound such as a polyolefin that has adherence to the positive electrode lead 31. Examples of the polyolefin include polypropylene.

A configuration of the sealing film 42 is similar to that of the sealing film 41 except that the sealing film 42 is a sealing member that has adherence to the negative electrode lead 32. That is, the sealing film 42 includes a polymer compound such as a polyolefin that has adherence to the negative electrode lead 32.

As illustrated in FIGS. 1 and 2, the battery device 20 is a power generation device that includes the positive electrode 21, the negative electrode 22, a separator 23, and the electrolytic solution (not illustrated). The battery device 20 is contained inside the outer package film 10.

Here, the battery device 20 is a so-called wound electrode body. That is, in the battery device 20, the positive electrode 21 and the negative electrode 22 are stacked on each other with the separator 23 interposed therebetween, and the positive electrode 21, the negative electrode 22, and the separator 23 are wound about a winding axis P. The winding axis P is a virtual axis extending in a Y-axis direction. Thus, the positive electrode 21 and the negative electrode 22 are opposed to each other with the separator 23 interposed therebetween, and are wound.

A three-dimensional shape of the battery device 20 is not particularly limited. Here, the battery device 20 has an elongated shape. Accordingly, a section of the battery device 20 intersecting the winding axis P, that is, a section of the battery device 20 along the XZ plane, has an elongated shape defined by a major axis J1 and a minor axis J2. The major axis J1 is a virtual axis that extends in an X-axis direction and has a larger length than the minor axis J2. The minor axis J2 is a virtual axis that extends in a Z-axis direction intersecting the X-axis direction and has a smaller length than the major axis J1. Here, the battery device 20 has an elongated cylindrical three-dimensional shape. Thus, the section of the battery device 20 has an elongated, generally elliptical shape.

The positive electrode 21 includes, as illustrated in FIG. 2, a positive electrode current collector 21A and a positive electrode active material layer 21B.

The positive electrode current collector 21A has two opposed surfaces on each of which the positive electrode active material layer 21B is to be provided. The positive electrode current collector 21A includes an electrically conductive material such as a metal material. Examples of the metal material include aluminum.

Here, the positive electrode active material layer 21B is provided on each of the two opposed surfaces of the positive electrode current collector 21A. The positive electrode active material layer 21B includes one or more of positive electrode active materials into which lithium is insertable and from which lithium is extractable. Note that the positive electrode active material layer 21B may be provided only on one of the two opposed surfaces of the positive electrode current collector 21A. In addition, the positive electrode active material layer 21B may further include, for example, a positive electrode binder and a positive electrode conductor. A method of forming the positive electrode active material layer 21B is not particularly limited, and specifically includes one or more of methods including, without limitation, a coating method.

The positive electrode active material is not particularly limited in kind, and specific examples thereof include a lithium-containing compound. The lithium-containing compound is a compound that includes lithium and one or more transition metal elements as one or more constituent elements. The lithium-containing compound may further include one or more other elements as one or more constituent elements. The one or more other elements are not particularly limited in kind as long as the one or more other elements are each an element other than lithium and the transition metal elements. Specifically, the one or more other elements are any one or more of elements belonging to groups 2 to 15 in the long period periodic table. The lithium-containing compound is not particularly limited in kind, and is specifically an oxide, a phosphoric acid compound, a silicic acid compound, or a boric acid , for example.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, LiNi0.8Co_{0.15}Al_{0.05}O₂, LiNi_{0.33}Co_{0.33}Mn0.33O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

The positive electrode binder includes one or more of materials including, without limitation, a synthetic rubber and a polymer compound. Examples of the synthetic rubber include a styrene-butadiene-based rubber, a fluorine-based rubber, and ethylene propylene diene. Examples of the polymer compound include polyvinylidene difluoride, polyimide, and carboxymethyl cellulose.

The positive electrode conductor includes one or more of electrically conductive materials including, without limitation, a carbon material. Examples of the carbon material include graphite, carbon black, acetylene black, and Ketjen black. Note that the electrically conductive material may be a metal material or a polymer compound, for example.

The negative electrode 22 includes, as illustrated in FIG. 2, a negative electrode current collector 22A and a negative electrode active material layer 22B.

The negative electrode current collector 22A has two opposed surfaces on each of which the negative electrode active material layer 22B is to be disposed. The negative electrode current collector 22A includes an electrically conductive material such as a metal material. Examples of the metal material include copper.

Here, the negative electrode active material layer 22B is provided on each of the two opposed surfaces of the negative electrode current collector 22A. The negative electrode active material layer 22B includes one or more of negative electrode active materials into which lithium is insertable and from which lithium is extractable. Note that the negative electrode active material layer 22B may be provided only on one of the two opposed surfaces of the negative electrode current collector 22A. In addition, the negative electrode active material layer 22B may further include, for example, a negative electrode binder and a negative electrode conductor. A method of forming the negative electrode active material layer 22B is not particularly limited, and specifically includes one or more of methods including, without limitation, a coating method, a vapor-phase method, a liquid-phase method, a thermal spraying method, and a firing (sintering) method.

The negative electrode active material is not particularly limited in kind, and specific examples thereof include a carbon material, a metal-based material, or both, for example. A reason for this is that a high energy density is obtainable. Examples of the carbon material include graphitizable carbon, non-graphitizable carbon, and graphite (natural graphite and artificial graphite). The term “metal-based material” is a generic term for a material that includes, as one or more constituent elements, one or more elements among metal elements and metalloid elements that are each able to form an alloy with lithium. Examples of such metal elements and metalloid elements include silicon, tin, or both. The metal-based material may be a simple substance, an alloy, a compound, a mixture of two or more thereof, or a material including two or more phases thereof. Specific examples of the metal-based material include TiSi₂ and SiOx (0<x≤2 or 0.2<x<1.4).

Details of the negative electrode binder are similar to those of the positive electrode binder. Details of the negative electrode conductor are similar to those of the positive electrode conductor.

As illustrated in FIG. 2, the separator 23 is an insulating porous film interposed between the positive electrode 21 and the negative electrode 22, and allows lithium ions to pass therethrough while preventing contact (a short circuit) between the positive electrode 21 and the negative electrode 22. The separator 23 includes a polymer compound such as polyethylene. (Electrolytic Solution)

The positive electrode 21, the negative electrode 22, and the separator 23 are each impregnated with the electrolytic solution, and the electrolytic solution has the configuration described above. That is, the electrolytic solution includes the diester compound and the sulfur-containing compound together.

As illustrated in FIG. 1, the positive electrode lead 31 is a positive electrode terminal coupled to the battery device 20 (the positive electrode 21). More specifically, the positive electrode lead 31 is coupled to the positive electrode current collector 21A. The positive electrode lead 31 is led from an inside to an outside of the outer package film 10. The positive electrode lead 31 includes an electrically conductive material such as aluminum. The positive electrode lead 31 is not particularly limited in shape, and specifically has a shape such as a thin plate shape or a meshed shape.

As illustrated in FIG. 1, the negative electrode lead 32 is a negative electrode terminal coupled to the battery device 20 (the negative electrode 22).

More specifically, the negative electrode lead 32 is coupled to the negative electrode current collector 22A. The negative electrode lead 32 is led from the inside to the outside of the outer package film 10. The negative electrode lead 32 includes an electrically conductive material such as copper. Here, the negative electrode lead 32 is led toward a direction similar to that in which the positive electrode lead 31 is led out. Note that details of a shape of the negative electrode lead 32 are similar to those of the shape of the positive electrode lead 31.

Upon charging the secondary battery, in the battery device 20, lithium is extracted from the positive electrode 21, and the extracted lithium is inserted into the negative electrode 22 via the electrolytic solution. Upon discharging the secondary battery, in the battery device 20, lithium is extracted from the negative electrode 22, and the extracted lithium is inserted into the positive electrode 21 via the electrolytic solution. Upon charging and discharging, lithium is inserted and extracted in an ionic state.

In a case of manufacturing the secondary battery, the positive electrode 21 and the negative electrode 22 are fabricated, following which the secondary battery is fabricated using the positive electrode 21, the negative electrode 22, and the electrolytic solution, according to a procedure to be described below. Note that the procedure for preparing the electrolytic solution is as described above.

First, a mixture (a positive electrode mixture) in which the positive electrode active material, the positive electrode binder, and the positive electrode conductor are mixed with each other is put into the solvent to thereby prepare a paste positive electrode mixture slurry. The solvent may be an aqueous solvent, or may be an organic solvent. Thereafter, the positive electrode mixture slurry is applied on the two opposed surfaces of the positive electrode current collector 21A to thereby form the positive electrode active material layers 21B. Thereafter, the positive electrode active material layers 21B may be compression-molded by means of, for example, a roll pressing machine. In this case, the positive electrode active material layers 21B may be heated. The positive electrode active material layers 21B may be compression-molded multiple times. In this manner, the positive electrode active material layers 21B are formed on the respective two opposed surfaces of the positive electrode current collector 21A. As a result, the positive electrode 21 is fabricated.

The negative electrode 22 is formed by a procedure similar to the fabrication procedure of the positive electrode 21 described above. Specifically, first, a mixture (a negative electrode mixture) in which the negative electrode active material, the negative electrode binder, and the negative electrode conductor are mixed with each other is put into the solvent to thereby prepare a paste negative electrode mixture slurry. A kind of the solvent is as described above. Thereafter, the negative electrode mixture slurry is applied on the two opposed surfaces of the negative electrode current collector 22A to thereby form the negative electrode active material layers 22B. Thereafter, the negative electrode active material layers 22B may be compression-molded. In this manner, the negative electrode active material layers 22B are formed on the respective two opposed surfaces of the negative electrode current collector 22A. As a result, the negative electrode 22 is fabricated.

First, the positive electrode lead 31 is coupled to the positive electrode 21 (the positive electrode current collector 21A) by a method such as a welding method, and the negative electrode lead 32 is coupled to the negative electrode 22 (the negative electrode current collector 22A) by a method such as a welding method.

Thereafter, the positive electrode 21 and the negative electrode 22 are stacked on each other with the separator 23 interposed therebetween, following which the stack of the positive electrode 21, the negative electrode 22, and the separator 23 is wound to thereby fabricate a wound body (not illustrated). The wound body has a configuration similar to that of the battery device 20 except that the positive electrode 21, the negative electrode 22, and the separator 23 are each not impregnated with the electrolytic solution. Thereafter, the wound body is pressed by means of, for example, a pressing machine to thereby shape the wound body into an elongated shape.

Thereafter, the wound body is placed inside the depression part 10U, following which the outer package film 10 (the fusion-bonding layer/the metal layer/the surface protective layer) is folded to thereby cause portions of the outer package film 10 to be opposed to each other. Thereafter, outer edge parts of two sides of the outer package film 10 (the fusion-bonding layer) opposed to each other are bonded to each other by a method such as a thermal-fusion-bonding method to thereby contain the wound body in the outer package film 10 having the pouch shape.

Lastly, the electrolytic solution is injected into the outer package film 10 having the pouch shape, following which the outer edge parts of the remaining one side of the outer package film 10 (the fusion-bonding layer) are bonded to each other by a method such as a thermal-fusion-bonding method. In this case, the sealing film 41 is interposed between the outer package film 10 and the positive electrode lead 31, and the sealing film 42 is interposed between the outer package film 10 and the negative electrode lead 32.

The wound body is thereby impregnated with the electrolytic solution. Thus, the battery device 20 that is a wound electrode body is fabricated, and the battery device 20 is sealed in the outer package film 10 having the pouch shape. As a result, the secondary battery is assembled.

The assembled secondary battery is charged and discharged. Conditions including, for example, an environment temperature, the number of times of charging and discharging (the number of cycles), and charging and discharging conditions may be set as desired. As a result, a film is formed on a surface of each of the positive electrode 21 and the negative electrode 22, which electrochemically stabilizes a state of the secondary battery. As a result, the secondary battery of the laminated-film type including the outer package film 10 is completed.

According to the secondary battery, the electrolytic solution described above is included. In this case, as described above, the film derived from both of the diester compound and the sulfur-containing compound is formed on the surface of each of the positive electrode 21 and the negative electrode 22 upon charging and discharging, which electrochemically protects the surface of the positive electrode 12 and the surface of the negative electrode 22. Accordingly, a decomposition reaction of the electrolytic solution is effectively suppressed even if the secondary battery is stored in a high-temperature environment. It is thus possible to achieve a superior storage characteristic.

In particular, the secondary battery may include a lithium-ion secondary battery. In this case, a sufficient battery capacity is stably obtainable through the use of insertion and extraction of lithium. It is thus possible to achieve higher effects.

Other actions and effects of the secondary battery are similar to those of the electrolytic solution described above.

The configuration of the secondary battery described above is appropriately modifiable as described below. Note that any two or more of the following series of modifications may be combined with each other.

The separator 23 which is a porous film is used. However, although not specifically illustrated here, a separator of a stacked type including a polymer compound layer may be used instead of the separator 23 which is the porous film.

Specifically, the separator of the stacked type includes a porous film having two opposed surfaces, and the polymer compound layer disposed on one of or each of the two opposed surfaces of the porous film. A reason for this is that adherence of the separator to each of the positive electrode 21 and the negative electrode 22 improves to suppress the occurrence of misalignment (irregular winding) of the battery device 20. This helps to prevent the secondary battery from easily swelling even if, for example, the decomposition reaction of the electrolytic solution occurs. The polymer compound layer includes a polymer compound such as polyvinylidene difluoride. A reason for this is that the polymer compound such as polyvinylidene difluoride has superior physical strength and is electrochemically stable.

Note that the porous film, the polymer compound layer, or both may each include one or more kinds of insulating particles. A reason for this is that the insulating particles dissipate heat upon heat generation by the secondary battery, thus improving safety or heat resistance of the secondary battery. Examples of the insulating particles include inorganic particles and resin particles. Specific examples of the inorganic particles include particles of: aluminum oxide, aluminum nitride, boehmite, silicon oxide, titanium oxide, magnesium oxide, and zirconium oxide. Specific examples of the resin particles include particles of acrylic resin and particles of styrene resin.

In a case of fabricating the separator of the stacked type, a precursor solution including, without limitation, the polymer compound and a solvent is prepared, following which the precursor solution is applied on one of or each of the two opposed surfaces of the porous film. In this case, insulating particles may be added to the precursor solution on an as-needed basis.

In the case where the separator of the stacked type is used also, lithium ions are movable between the positive electrode 21 and the negative electrode 22, and similar effects are therefore obtainable.

The electrolytic solution which is a liquid electrolyte is used. However, although not specifically illustrated here, an electrolyte layer which is a gel electrolyte may be used instead of the electrolytic solution.

In the battery device 20 including the electrolyte layer, the positive electrode 21 and the negative electrode 22 are stacked on each other with the separator 23 and the electrolyte layer interposed therebetween, following which the stack of the positive electrode 21, the negative electrode 22, the separator 23, and the electrolyte layer is wound. The electrolyte layer is interposed between the positive electrode 21 and the separator 23, and between the negative electrode 22 and the separator 23.

Specifically, the electrolyte layer includes a polymer compound together with the electrolytic solution. The electrolytic solution is held by the polymer compound. A reason for this is that liquid leakage of the electrolytic solution is prevented. The configuration of the electrolytic solution is as described above. The polymer compound includes, for example, polyvinylidene difluoride. In a case of forming the electrolyte layer, a precursor solution including, for example, the electrolytic solution, the polymer compound, and a solvent is prepared, following which the precursor solution is applied on one side or both sides of the positive electrode 21 and on one side or both sides of the negative electrode 22.

In a case where the electrolyte layer is used also, lithium ions are movable between the positive electrode 21 and the negative electrode 22 via the electrolyte layer, and similar effects are therefore obtainable.

Applications (application examples) of the secondary battery are not particularly limited. The secondary battery used as a power source serves as a main power source or an auxiliary power source of, for example, electronic equipment and an electric vehicle. The main power source is preferentially used regardless of the presence of any other power source. The auxiliary power source is used in place of the main power source, or is switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems or industrial battery systems for accumulation of electric power for a situation such as emergency. The above-described applications may each use one secondary battery, or may each use multiple secondary batteries.

The battery packs may each include a single battery, or may each include an assembled battery. The electric vehicle is a vehicle that operates (travels) using the secondary battery as a driving power source, and may be a hybrid automobile that is additionally provided with a driving source other than the secondary battery. In an electric power storage system for home use, electric power accumulated in the secondary battery which is an electric power storage source may be utilized for using, for example, home appliances.

An application example of the secondary battery will now be described in detail. The configuration of the application example described below is merely an example, and is appropriately modifiable.

FIG. 3 illustrates a block configuration of a battery pack. The battery pack described here is a battery pack (a so-called soft pack) including one secondary battery, and is to be mounted on, for example, electronic equipment typified by a smartphone.

As illustrated in FIG. 3, the battery pack includes an electric power source 51 and a circuit board 52. The circuit board 52 is coupled to the electric power source 51, and includes a positive electrode terminal 53, a negative electrode terminal 54, and a temperature detection terminal 55.

The electric power source 51 includes one secondary battery. The secondary battery has a positive electrode lead coupled to the positive electrode terminal 53 and a negative electrode lead coupled to the negative electrode terminal 54. The electric power source 51 is couplable to outside via the positive electrode terminal 53 and the negative electrode terminal 54, and is thus chargeable and dischargeable. The circuit board 52 includes a controller 56, a switch 57, a thermosensitive resistive device (a PTC device) 58, and a temperature detector 59. However, the PTC device 58 may be omitted.

The controller 56 includes, for example, a central processing unit (CPU) and a memory, and controls an overall operation of the battery pack. The controller 56 detects and controls a use state of the electric power source 51 on an as-needed basis.

If a voltage of the electric power source 51 (the secondary battery) reaches an overcharge detection voltage or an overdischarge detection voltage, the controller 56 turns off the switch 57. This prevents a charging current from flowing into a current path of the electric power source 51. The overcharge detection voltage is not particularly limited, and is specifically 4.2 V±0.05 V. The overdischarge detection voltage is not particularly limited, and is specifically 2.4 V ±0.1 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes, for example, a metal-oxide-semiconductor field-effect transistor (MOSFET). The charging and discharging currents are detected based on an ON-resistance of the switch 57.

The temperature detector 59 includes a temperature detection device such as a thermistor. The temperature detector 59 measures a temperature of the electric power source 51 using the temperature detection terminal 55, and outputs a result of the temperature measurement to the controller 56. The result of the temperature measurement to be obtained by the temperature detector 59 is used, for example, in a case where the controller 56 performs charge/discharge control upon abnormal heat generation or in a case where the controller 56 performs a correction process upon calculating a remaining capacity.

### EXAMPLES

A description is given of Examples of the present technology according to an embodiment.

### Experiment Examples 1 to 17 and Comparative Examples 1 to 7

Secondary batteries were manufactured, following which the secondary batteries were each evaluated for a battery characteristic as described below.

### [Fabrication of Secondary Battery]

The secondary batteries (lithium-ion secondary batteries) of the laminated-film type illustrated in FIGS. 1 and 2 were manufactured in accordance with the following procedure. (Fabrication of Positive Electrode)

First, 91 parts by mass of the positive electrode active material (lithium cobalt oxide (LiCoO₂)), 3 parts by mass of the positive electrode binder (polyvinylidene difluoride), and 6 part by mass of the positive electrode conductor (graphite) were mixed with each other to thereby obtain a positive electrode mixture. Thereafter, the positive electrode mixture was put into a solvent (N-methyl-2-pyrrolidone which is an organic solvent), following which the organic solvent was stirred to thereby prepare a paste positive electrode mixture slurry. Thereafter, the positive electrode mixture slurry was applied on the two opposed surfaces of the positive electrode current collector 21A (a band-shaped aluminum foil having a thickness of 12 μm) by means of a coating apparatus, following which the applied positive electrode mixture slurry was dried to thereby form the positive electrode active material layers 21B. Lastly, the positive electrode active material layers 21B were compression-molded by means of a roll pressing machine. In this manner, the positive electrode 21 was fabricated.

### (Fabrication of Negative Electrode)

First, 93 parts by mass of the negative electrode active material (artificial graphite which is a carbon material) and 7 parts by mass of the negative electrode binder (polyvinylidene difluoride) were mixed with each other to thereby obtain a negative electrode mixture. Thereafter, the negative electrode mixture was put into a solvent (N-methyl-2-pyrrolidone which is an organic solvent), following which the organic solvent was stirred to thereby prepare a paste negative electrode mixture slurry. Thereafter, the negative electrode mixture slurry was applied on the two opposed surfaces of the negative electrode current collector 22A (a band-shaped copper foil having a thickness of 15 μm) by means of a coating apparatus, following which the applied negative electrode mixture slurry was dried to thereby form the negative electrode active material layers 22B. Lastly, the negative electrode active material layers 22B were compression-molded by means of a roll pressing machine. In this manner, the negative electrode 22 was fabricated.

### (Preparation of Electrolytic Solution)

First, a solvent was prepared. Used as the solvent were ethylene carbonate and diethyl carbonate which are each the carbonic-acid-ester-based compound (the cyclic carbonic acid ester or the chain carbonic acid ester), and propyl propionate and ethyl propionate which are each the carboxylic-acid-ester-based compound (the chain carboxylic acid ester). A mixture ratio (a weight ratio) of the solvent between ethylene carbonate, diethyl carbonate, propyl propionate, and ethyl propionate was set to 30:10:30:30.

Thereafter, an electrolyte salt (lithium hexafluorophosphate (LiPF₆)) was added to the solvent, following which the solvent was stirred. A content of the electrolyte salt was set to 1 mol/kg with respect to the solvent.

Thereafter, additives (vinylene carbonate which is the unsaturated cyclic carbonic acid ester, and fluoroethylene carbonate which is the halogenated carbonic acid ester) were added to the solvent, following which the solvent was stirred.

Lastly, the diester compound and the sulfur-containing compound were added to the solvent, following which the solvent was stirred. A kind of each of the diester compound and the sulfur-containing compound was as presented in Table 1. The electrolyte salt, the additives, the diester compound, and the sulfur-containing compound were thereby each dispersed or dissolved in the solvent. As a result, the electrolytic solution was prepared.

Note that an electrolytic solution for comparison was prepared by a similar procedure except that neither the diester compound nor the sulfur-containing compound was used.

In addition, an electrolytic solution for comparison was prepared by a similar procedure except that the other compound was used instead of the sulfur-containing compound. A kind of the other compound was as presented in Table 1.

### (Assembly of Secondary Battery)

First, the positive electrode lead 31 including aluminum was welded to the positive electrode 21 (the positive electrode current collector 21A), and the negative electrode lead 32 including copper was welded to the negative electrode 22 (the negative electrode current collector 22A).

Thereafter, the positive electrode 21 and the negative electrode 22 were stacked on each other with the separator 23 (a fine porous polyethylene film having a thickness of 15 μm) interposed therebetween, following which the stack of the positive electrode 21, the negative electrode 22, and the separator 23 was wound to thereby fabricate a wound body. Thereafter, the wound body was pressed by means of a pressing machine, and was thereby shaped into an elongated shape.

Thereafter, the outer package film 10 (the fusion-bonding layer/the metal layer/the surface protective layer) was folded in such a manner as to sandwich the wound body contained inside the depression part 10U, following which the outer edge parts of two sides of the outer package film 10 (the fusion-bonding layer) were thermal-fusion-bonded to each other to thereby allow the wound body to be contained inside the outer package film 10 having the pouch shape. As the outer package film 10, an aluminum laminated film was used in which a fusion-bonding layer (a polypropylene film having a thickness of 30 μpm), a metal layer (an aluminum foil having a thickness of 40 μm), and a surface protective layer (a nylon film having a thickness of 25 μm) were stacked in this order from an inner side.

Lastly, the electrolytic solution was injected into the outer package film 10 having the pouch shape and thereafter, the outer edge parts of the remaining one side of the outer package film 10 (the fusion-bonding layer) were thermal-fusion-bonded to each other in a reduced-pressure environment. In this case, the sealing film 41 (a polypropylene film having a thickness of 5 μm) was interposed between the outer package film 10 and the positive electrode lead 31, and the sealing film 42 (a polypropylene film having a thickness of 5 μm) was interposed between the outer package film 10 and the negative electrode lead 32. In this manner, the wound body was impregnated with the electrolytic solution. As a result, the battery device 20 was fabricated.

Accordingly, the battery device was sealed in the outer package film 10. As a result, the secondary battery was assembled.

### (Stabilization of Secondary Battery)

The secondary battery was charged and discharged for one cycle in an ambient temperature environment (at a temperature of 23° C.). Upon charging, the secondary battery was charged with a constant current of 0.1 C until a voltage reached 4.2 V, and was thereafter charged with a constant voltage of 4.2 V until a current reached 0.05 C. Upon the discharging, the secondary battery was discharged with a constant current of 0.1 C until the voltage reached 3.0 V. Note that 0.1 C is a value of a current that causes a battery capacity (a theoretical capacity) to be completely discharged in 10 hours, and 0.05 C is a value of a current that causes the battery capacity to be completely discharged in 20 hours.

In this manner, a film was formed on the surface of each of the positive electrode 21 and the negative electrode 22, which electrochemically stabilized the state of the secondary battery. As a result, the secondary battery of the laminated-film type was completed.

After the completion of the secondary battery, the electrolytic solution was analyzed by inductively coupled plasma (ICP) optical emission spectroscopy. The result of analysis revealed that a content of the unsaturated cyclic carbonic acid ester in the electrolytic solution was 1 wt %, and a content of the halogenated carbonic acid ester in the electrolytic solution was 1 wt %. In addition, the result of measurement of a content (wt %) in the electrolytic solution of each of the diester compound, the sulfur-containing compound, and the other compound was as indicated in Table 1.

### [Evaluation of Battery Characteristic]

Evaluation of the secondary batteries for their battery characteristics (high-temperature storage characteristics) revealed the results presented in Table 1.

In a case of examining the high-temperature storage characteristic, first, the secondary battery was charged and discharged for one cycle in an ambient temperature environment (at a temperature of 25° C.) to thereby measure a first-cycle discharge capacity (a pre-storage discharge capacity). Charging and discharging conditions were similar to those in the case of performing the stabilization treatment on the secondary battery described above.

Thereafter, the secondary battery in a charged state was stored in a high-temperature environment at a temperature of 60° C. for a storage time of four weeks.

Thereafter, the secondary battery was charged and discharged for three cycles in an ambient temperature environment to thereby measure a fourth-cycle discharge capacity (a post-storage discharge capacity). Charging and discharging conditions were similar to those in the case of performing the stabilization treatment on the secondary battery described above, except that the current at the time of charging and the current at the time of discharging were each changed to ⅓ C. Note that ⅓ C is a value of a current that causes the battery capacity to be completely discharged in three hours.

Lastly, a capacity retention rate which is an index for evaluating the high-temperature storage characteristic was calculated based on the following calculation expression: capacity retention rate (%)=(post-storage discharge capacity/pre-storage discharge capacity)×100.

TABLE 1

| | | | Sulfur-containing | | |
|---|---|---|---|---|---|
| | Diester compound | | compound | | Capacity |
| | | Content | | Content | retention |
| | Kind | (wt %) | Kind | (wt %) | rate (%) |
| Example 1 | Formula (1-1) | 0.01 | Formula (2-3) | 0.1 | 84 |
| Example 2 | Formula (1-14) | 0.01 | | 0.1 | 85 |
| Example 3 | Formula (1-1) | 0.01 | Formula (2-6) | 0.1 | 84 |
| Example 4 | Formula (1-14) | 0.01 | | 0.1 | 83 |
| Example 5 | Formula (1-1) | 0.01 | Formula (4-2) | 0.1 | 83 |
| Example 6 | Formula (1-14) | 0.01 | | 0.1 | 84 |
| Example 7 | Formula (1-1) | 0.01 | Formula (5-2) | 0.1 | 83 |
| Example 8 | Formula (1-14) | 0.01 | | 0.1 | 86 |
| Example 9 | Formula (1-15) | 0.01 | | 0.1 | 86 |
| Example 10 | Formula (1-20) | 0.01 | | 0.1 | 86 |
| Example 11 | Formula (1-34) | 0.01 | | 0.1 | 86 |
| Example 12 | Formula (1-1) | 0.01 | Formula (9-13) | 0.1 | 84 |
| Example 13 | Formula (1-14) | 0.01 | | 0.1 | 83 |
| Example 14 | Formula (1-1) | 0.01 | Formula (9-16) | 0.1 | 85 |
| Example 15 | Formula (1-14) | 0.01 | | 0.1 | 84 |
| Example 16 | Formula (1-1) | 0.01 | Formula (14-1) | 0.1 | 85 |
| Example 17 | Formula (1-14) | 0.01 | | 0.1 | 84 |
| Comparative Example 1 | — | — | — | — | 70 |
| Comparative Example 2 | Formula (1-1) | 0.01 | Formula (17-1) | 0.1 | 71 |
| Comparative Example 3 | Formula (1-14) | 0.01 | | 0.1 | 71 |
| Comparative Example 4 | Formula (1-1) | 0.01 | Formula (17-2) | 0.1 | 71 |
| Comparative Example 5 | Formula (1-14) | 0.01 | | 0.1 | 71 |
| Comparative Example 6 | Formula (1-1) | 0.01 | Formula (17-3) | 0.1 | 71 |
| Comparative Example 7 | Formula (1-1) | 0.01 | Formula (17-4) | 0.1 | 71 |

As presented in Table 1, the capacity retention rate varied greatly depending on the configuration of the electrolytic solution. Hereinafter, the capacity retention rate in a case of the electrolytic solution including neither the diester compound nor the sulfur-containing compound (Comparative Example 1) is set as a comparison reference.

In a case of the electrolytic solution including the diester compound and the other compound (Comparative Examples 2 to 7), the capacity retention rate increased only slightly, and thus a high capacity retention rate was not obtained. In contrast, in a case of the electrolytic solution including the diester compound and the sulfur-containing compound (Experiment Examples 1 to 17), the capacity retention rate largely increased, and thus a markedly high capacity retention rate was obtained.

### Examples 18 to 25

As presented in Table 2, secondary batteries were fabricated by a similar procedure except that the content of each of the diester compound and the sulfur-containing compound in the electrolytic solution was changed, following which the secondary batteries were each evaluated for a battery characteristic.

TABLE 2

| | | | Sulfur-containing | | |
|---|---|---|---|---|---|
| | Diester compound | | compound | | Capacity |
| | | Content | | Content | retention |
| | Kind | (wt %) | Kind | (wt %) | rate (%) |
| Example 18 | Formula | 0.01 | Formula | 0.0005 | 78 |
| Example 19 | (1-14) | | (5-2) | 0.001 | 81 |
| Example 8 | | | | 0.1 | 86 |
| Example 20 | | | | 5 | 83 |
| Example 21 | | | | 5.5 | 79 |
| Example 22 | Formula | 0.0005 | Formula | 0.1 | 80 |
| Example 23 | (1-14) | 0.001 | (5-2) | | 82 |
| Example 8 | | 0.01 | | | 86 |
| Example 24 | | 5 | | | 83 |
| Example 25 | | 5.5 | | | 80 |

As presented in Table 2, in a case where the content of the diester compound in the electrolytic solution was within a range from 0.001 wt % to 5 wt % both inclusive (Examples 8, 19, and 20), the capacity retention rate further increased. In addition, in a case where the content of the sulfur-containing compound in the electrolytic solution was within a range from 0.001 wt % to 5 wt % both inclusive (Examples 8, 23, and 24), the capacity retention rate further increased.

The results presented in Tables 1 and 2 revealed that a high capacity retention rate was obtained in a case where the electrolytic solution included the diester compound and the sulfur-containing compound together. It was thus possible to achieve a superior storage characteristic of the secondary battery.

Although the present technology has been described above with reference to one or embodiments including Examples, the configuration of the present technology is not limited thereto, and is therefore modifiable in a variety of ways.

Specifically, the description has been given of the case where the secondary battery has a battery structure of the laminated-film type. However, the battery structure of the secondary battery is not particularly limited, and may thus be, for example, of a cylindrical type, a prismatic type, a coin type, or a button type.

Further, the description has been given of the case where the battery device has a device structure of a wound type. However, the device structure of the battery device is not particularly limited, and may thus be, for example, of a stacked type in which the positive electrode and the negative electrode are stacked on each other, or a zigzag folded type in which the positive electrode and the negative electrode are folded in a zigzag manner.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. Alternatively, the electrode reactant may be another light metal such as aluminum.

Note that the applications of the electrolytic solution described above are not limited to a secondary battery. The electrolytic solution may thus be applied to another electrochemical device such as a capacitor.

The effects described herein are mere examples, and effects of the present technology are therefore not limited to those described herein. Accordingly, the present technology may achieve other effects.

It should be that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode; and
an electrolytic solution including a solvent, an electrolyte salt, a diester compound represented by Formula (1), and at least one of respective sulfur-containing compounds represented by Formulae (2) to (14), 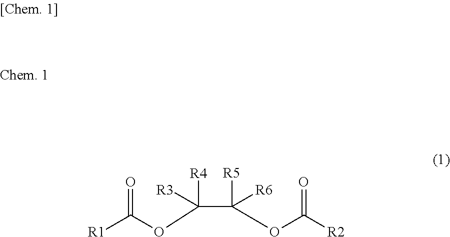
where
each of R1 and R2 is one of a halogen group, an alkyl group, an alkoxy group, a halogenated alkyl group, or a halogenated alkoxy group, and
each of R3 to R6 is one of a hydrogen group, a halogen group, an alkyl group, or a halogenated alkyl group, 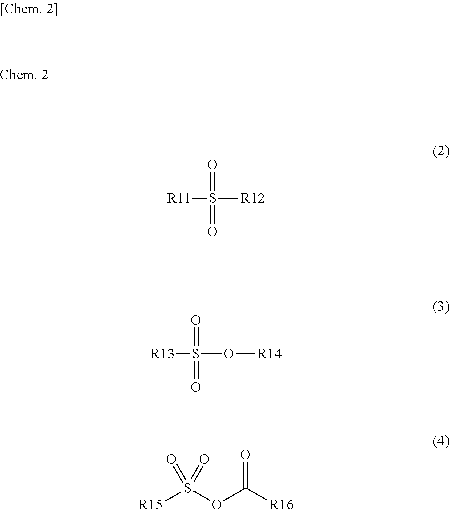
where
each of R11 and R12 is one of an alkyl group, an alkenyl group, an aryl group, a halogenated alkyl group, a halogenated alkenyl group, or a halogenated aryl group,
R11 and R12 are optionally bonded to each other,
R13 is one of an alkyl group, an aryl group, a hydroxyalkyl group, a lithium alkoxide group, a halogenated alkyl group, or a halogenated aryl group,
R14 is one of a hydrogen group, a lithium group, an alkyl group, or a halogenated alkyl group,
each of R15 and R16 is one of an alkyl group, an alkenyl group, an aryl group, a halogenated alkyl group, a halogenated alkenyl group, or a halogenated aryl group, and
R15 and R16 are optionally bonded to each other, 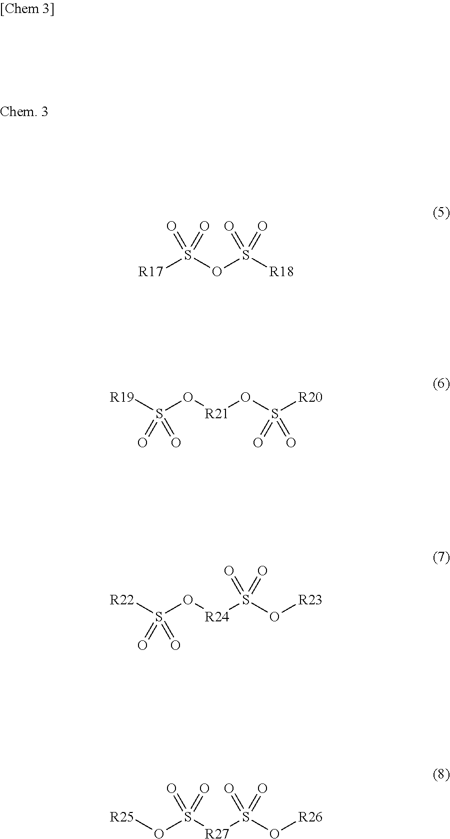
where
each of R17 and R18 is one of an alkyl group, an alkenyl group, an aryl group, a halogenated alkyl group, a halogenated alkenyl group, or a halogenated aryl group,
R17 and R18 are optionally bonded to each other,
each of R19 and R20 is one of an alkyl group or a halogenated alkyl group,
R21 is one of an alkylene group or a halogenated alkylene group,
R22 is one of an alkyl group or a halogenated alkyl group,
R23 is one of a hydrogen group, a lithium group, an alkyl group, or a halogenated alkyl group,
R24 is one of an alkylene group or a halogenated alkylene group,
each of R25 and R26 is one of a hydrogen group, a lithium group, an alkyl group, or a halogenated alkyl group, and
R27 is one of an alkylene group or a halogenated alkylene group, 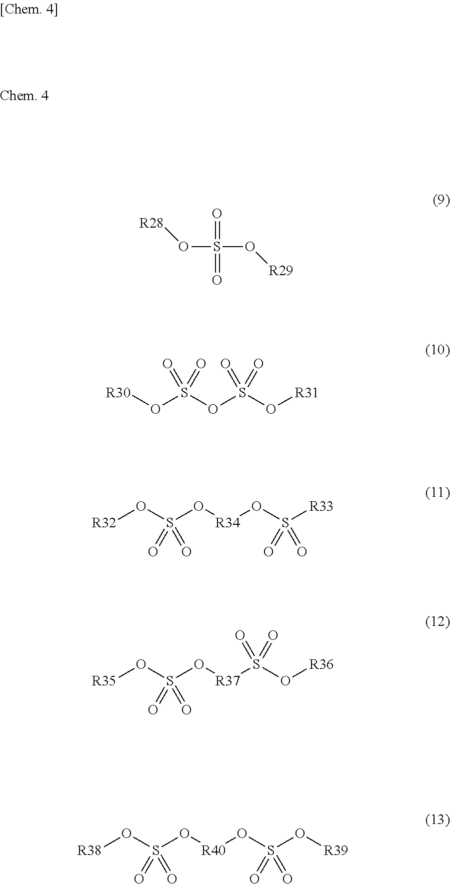
where
each of R28 and R29 is one of a hydrogen group, a lithium group, an alkyl group, a hydroxyalkyl group, a lithium alkoxide group, or a halogenated alkyl group,
R28 and R29 are optionally bonded to each other,
1,2-ethylenesulfate and 1-methyl-1,2-ethylenesulfate are excluded from the sulfur-containing compound represented by Formula (9),
each of R30 and R31 is one of an alkyl group, an alkenyl group, an aryl group, a halogenated alkyl group, a halogenated alkenyl group, or a halogenated aryl group,
R30 and R31 are optionally bonded to each other,
R32 is one of a hydrogen group, a lithium group, an alkyl group, or a halogenated alkyl group,
R33 is one of an alkyl group or a halogenated alkyl group,
R34 is one of an alkylene group or a halogenated alkylene group,
each of R35 and R36 is one of a hydrogen group, a lithium group, an alkyl group, or a halogenated alkyl group,
R37 is one of an alkylene group or a halogenated alkylene group,
each of R38 and R39 is one of a hydrogen group, a lithium group, an alkyl group, or a halogenated alkyl group, and
R40 is one of an alkylene group or a halogenated alkylene group, 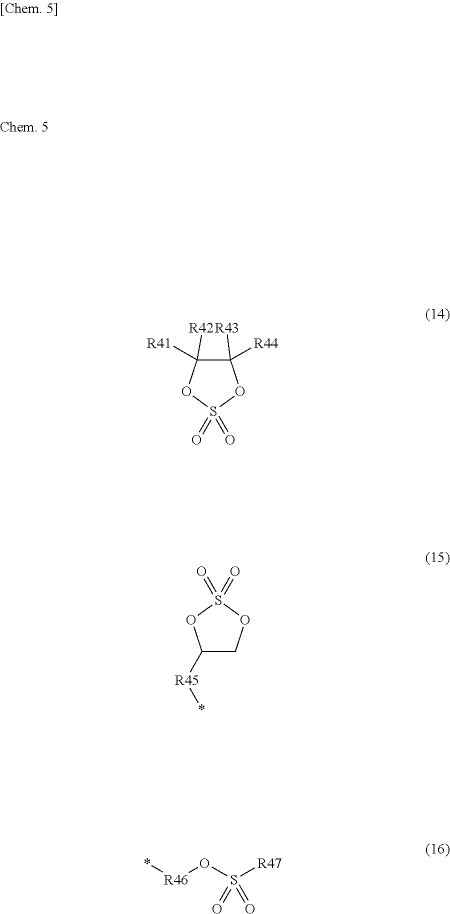
where
each of R41 to R44 is one of a hydrogen group, an alkyl group, a halogenated alkyl group, a group represented by Formula (15), or a group represented by Formula (16),
at least one of R41 to R44 is one of the group represented by Formula (15) or the group represented by Formula (16),
each of R45 and R46 is one of an alkylene group or a halogenated alkylene group, or is omitted,
R47 is one of an alkyl group or a halogenated alkyl group, and
an asterisk (*) in each of Formula (15) and Formula (16) represents a bond.

2. The secondary battery according to claim 1, wherein
carbon number of each of the alkyl group, the alkoxy group, the hydroxyalkyl group, the lithium alkoxide group, the halogenated alkyl group, and the halogenated alkoxy group is greater than or equal to 1 and less than or equal to 4,
carbon number of each of the alkenyl group and the halogenated alkenyl group is greater than or equal to 2 and less than or equal to 4,
carbon number of each of the aryl group and the halogenated aryl group is greater than or equal to 6 and less than or equal to 10, and
carbon number of each of the alkylene group and the halogenated alkylene group is greater than or equal to 1 and less than or equal to 4.

3. The secondary battery according to claim 1, wherein a content of the diester compound in the electrolytic solution is greater than or equal to 0.001 percent by weight and less than or equal to 5 percent by weight.

4. The secondary battery according to claim 1, wherein a content of the sulfur-containing compound in the electrolytic solution is greater than or equal to 0.001 percent by weight and less than or equal to 5 percent by weight.

5. The secondary battery according to claim 1, wherein the secondary battery comprises a lithium-ion secondary battery.

6. An electrolytic solution for a secondary battery, the electrolytic solution comprising:
a solvent;
an electrolyte salt;
a diester compound represented by Formula (1); and
at least one of respective sulfur-containing compounds represented by Formulae (2) to (14), 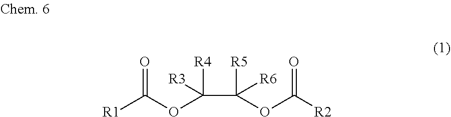
where
each of R1 and R2 is one of a halogen group, an alkyl group, an alkoxy group, a halogenated alkyl group, or a halogenated alkoxy group, and
each of R3 to R6 is one of a hydrogen group, a halogen group, an alkyl group, or a halogenated alkyl group, 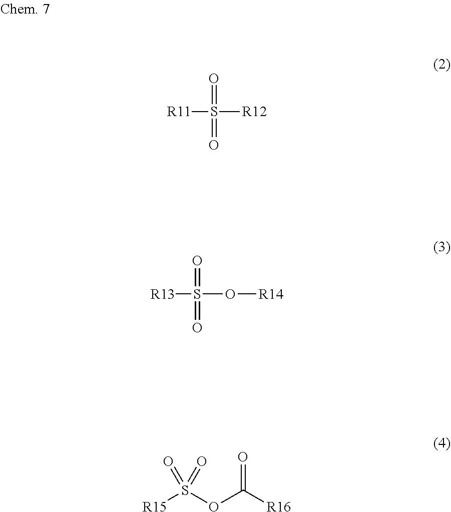
where
each of R11 and R12 is one of an alkyl group, an alkenyl group, an aryl group, a halogenated alkyl group, a halogenated alkenyl group, or a halogenated aryl group,
R11 and R12 are optionally bonded to each other,
R13 is one of an alkyl group, an aryl group, a hydroxyalkyl group, a lithium alkoxide group, a halogenated alkyl group, or a halogenated aryl group,
R14 is one of a hydrogen group, a lithium group, an alkyl group, or a halogenated alkyl group,
each of R15 and R16 is one of an alkyl group, an alkenyl group, an aryl group, a halogenated alkyl group, a halogenated alkenyl group, or a halogenated aryl group, and
R15 and R16 are optionally bonded to each other, 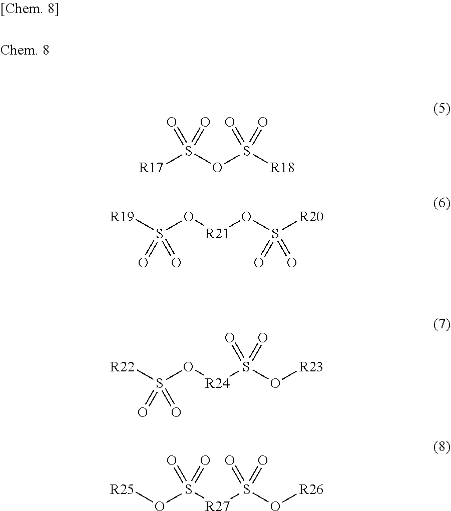
where
each of R17 and R18 is one of an alkyl group, an alkenyl group, an aryl group, a halogenated alkyl group, a halogenated alkenyl group, or a halogenated aryl group,
R17 and R18 are optionally bonded to each other,
each of R19 and R20 is one of an alkyl group or a halogenated alkyl group,
R21 is one of an alkylene group or a halogenated alkylene group,
R22 is one of an alkyl group or a halogenated alkyl group,
R23 is one of a hydrogen group, a lithium group, an alkyl group, or a halogenated alkyl group,
R24 is one of an alkylene group or a halogenated alkylene group,
each of R25 and R26 is one of a hydrogen group, a lithium group, an alkyl group, or a halogenated alkyl group, and
R27 is one of an alkylene group or a halogenated alkylene group, 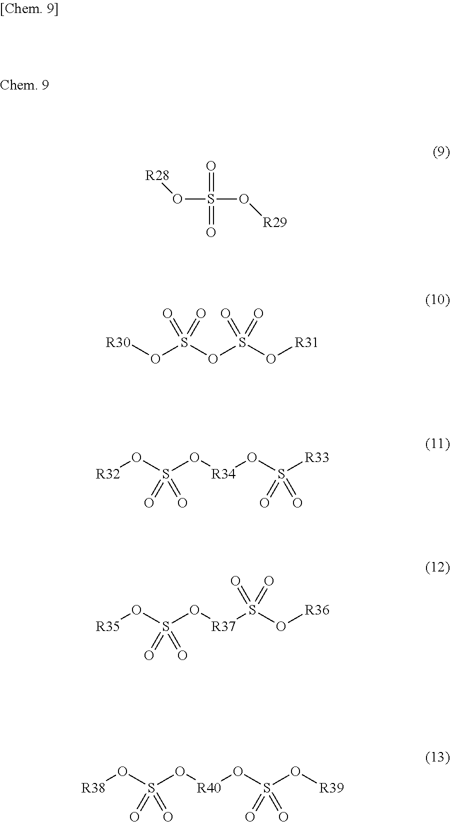
where
each of R28 and R29 is one of a hydrogen group, a lithium group, an alkyl group, a hydroxyalkyl group, a lithium alkoxide group, or a halogenated alkyl group,
R28 and R29 are optionally bonded to each other,
1,2-ethylenesulfate and 1-methyl-1,2-ethylenesulfate are excluded from the sulfur-containing compound represented by Formula (9),
each of R30 and R31 is one of an alkyl group, an alkenyl group, an aryl group, a halogenated alkyl group, a halogenated alkenyl group, or a halogenated aryl group,
R30 and R31 are optionally bonded to each other,
R32 is one of a hydrogen group, a lithium group, an alkyl group, or a halogenated alkyl group,
R33 is one of an alkyl group or a halogenated alkyl group,
R34 is one of an alkylene group or a halogenated alkylene group,
each of R35 and R36 is one of a hydrogen group, a lithium group, an alkyl group, or a halogenated alkyl group,
R37 is one of an alkylene group or a halogenated alkylene group,
each of R38 and R39 is one of a hydrogen group, a lithium group, an alkyl group, or a halogenated alkyl group, and
R40 is one of an alkylene group or a halogenated alkylene group, 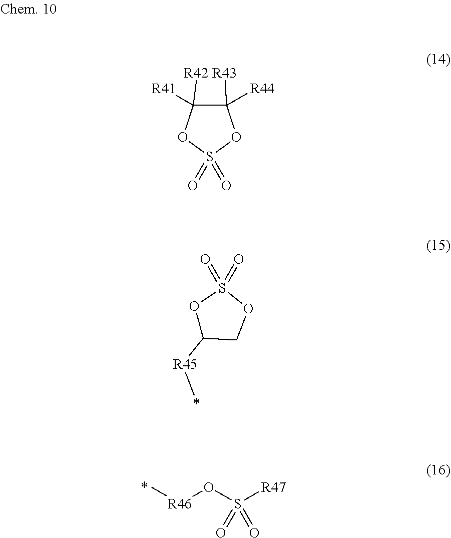
where
each of R41 to R44 is one of a hydrogen group, an alkyl group, a halogenated alkyl group, a group represented by Formula (15), or a group represented by Formula (16),
at least one of R41 to R44 is one of the group represented by Formula (15) or the group represented by Formula (16),
each of R45 and R46 is one of an alkylene group or a halogenated alkylene group, or is omitted,
R47 is one of an alkyl group or a halogenated alkyl group, and
an asterisk (*) in each of Formula (15) and Formula (16) represents a bond.
